(19) United States
(12) Patent Application Publication
(10) Pub. No.: US 2009/0077199 A1
(43) Pub. Date: Mar. 19, 2009

(54) PRESENCE INFORMATION PROCESSING SYSTEM, INFORMATION PROCESSING APPARATUS, AND PRESENCE DOCUMENT SCHEMA MANAGING SERVER

(75) Inventor: Mototsugu EMORI, Saitama (JP)

Correspondence Address: COOPER & DUNHAM, LLP, 30 Rockefeller Plaza, 20th Floor, NEW YORK, NY, 10112, US

(73) Assignee: RICOH COMPANY, LTD, TOKYO (JP)

(21) Appl. No.: 12/207,808

(22) Filed: Sep. 10, 2008

(30) Foreign Application Priority Data
Sep. 14, 2007 (JP) 2007-240092

(51) Int. Cl. G06F 15/16

(52) U.S. Cl. 709/218

(57) ABSTRACT

A disclosed presence information processing system in which plural information processing devices are connected for exchanging presence information among each other via a network, includes a schema information sharing unit that operates such that the information processing devices can share a presence document schema representing at least one of a structure of a presence document in which the presence information is described and vocabulary of the presence information.

### BACKGROUND OF THE INVENTION

1. Field of the Invention

The present invention relates to a presence information processing system, an information processing apparatus, and a presence document schema managing server.

2. Description of the Related Art

The recent years have witnessed the increasing popularity of IP telephones and instant messengers. Accordingly, presence systems are attracting attention, for sharing presence information representing the present state of people and things to perform increasingly smooth communication. As examples of such a presence system, there are known SIMPLE (SIP for Instant Messaging and Presence Leveraging Extensions) realized by SIP (Session Initiation Protocol) and XMPP (eXtensible Messaging and Presence Protocol).

In conventional presence systems, a predetermined presence server stores a presence document including presence information of each user, and the users (client devices) share the presence information. However, the format of the presence document is fixed, and therefore there has been a limit in extending the presence information. Furthermore, predefined status information that can be selected as the presence information, has been difficult to change in the conventional system.

In order to solve such a problem, for example, patent document 1 discloses a technology pertaining to a method of managing the presence document on the client device side. The method includes a step of receiving a new presence information report message including at least one difference representing a change in at least one corresponding information item of the presence document, a step of revising the at least one presence information item based on the at least one corresponding difference, a step of creating a revised presence document, a step of calculating a verification value in accordance with the revised presence document, a step of determining whether the verification value is equal to a received confirmation value, and a step of using the revised presence document in the event that it is determined that the verification value is equal to the received confirmation value.

In the technology disclosed in patent document 1, instead of having the presence server store the presence documents of the users, the client devices share the presence documents by a P2P (peer-to-peer) network. As the presence documents are locally held and shared by the P2P method, the amount of the presence information that can be held and communicated is less constrained compared to a presence system using a presence server. Furthermore, the presence information described in a presence document can be extended in accordance with a presence document schema.

Patent document 1: Japanese Laid-Open Patent Application No. 2006-244494

However, in the invention disclosed in patent document 1, no consideration is made for changing the presence document schema. Accordingly, extension of the presence information is limited by the presence document schema.

### SUMMARY OF THE INVENTION

The present invention provides a presence information processing system, an information processing apparatus, and a presence document schema managing server, in which one or more of the above-described disadvantages are eliminated.

A preferred embodiment of the present invention provides a presence information processing system, an information processing apparatus, and a presence document schema managing server, capable of effectively extending the presence information even when the presence document schema is changed.

According to an aspect of the present invention, there is provided a presence information processing system in which plural information processing devices are connected for exchanging presence information among each other via a network, the presence information processing system including a schema information sharing unit that operates in such that the plural information processing devices can share a presence document schema representing at least one of a structure of a presence document in which the presence information is described and vocabulary of the presence information.

According to another aspect of the present invention, there is provided an information processing device in a presence information processing system in which plural information processing devices are connected for exchanging presence information among each other via a network, the information processing device including a schema information sharing unit that operates in such that the information processing device and the plural information processing devices can share a presence document schema representing at least one of a structure of a presence document in which the presence information is described and vocabulary of the presence information.

According to another aspect of the present invention, there is provided a presence document schema managing server configured to manage a presence document schema for describing presence information, the presence document schema managing server being provided in a presence information processing system that includes plural information processing devices for exchanging the presence information among each other via a network, the presence document schema managing server including a presence document schema sending unit configured to send the presence document schema in response to a request from at least one of the plural information processing devices; an operating unit configured to operate the presence document schema; a revision number managing unit configured to manage a revision number of the presence document schema; a presence document conversion document creating unit configured to create a presence document conversion document, wherein in the event that the presence document schema being managed by the presence document schema managing server has been changed by an operation of the operating unit, the presence document that has been created in accordance with the presence document schema before being changed is converted, based on the presence document conversion document, so as to comply with the present document schema that has been changed; a presence document conversion document sending unit configured to send, in response to a request from at least one of the plural information processing devices; a change reporting unit configured to report, to the plural information processing devices, that the presence document schema has been changed by the operating unit; and an access right managing unit configured to manage an access right for accessing at least one of the presence document schema, the presence document conversion document, and the operating unit.

According to one embodiment of the present invention, a presence information processing system, an information, processing apparatus, and a presence document schema managing server are provided, which are capable of effectively extending the presence information even when the presence document schema is changed.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of an overall configuration of a presence information processing system according to a first embodiment of the present invention;

FIG. 2 illustrates an example of a presence document;

FIG. 3 illustrates an example of a presence document schema;

FIG. 4 is a schematic diagram of a data structure for describing how presence information is shared according to the first embodiment;

FIG. 5 is a sequence chart illustrating an example of a flow of editing a presence document schema according to the first embodiment;

FIG. 6 illustrates an example of a presence document conversion document;

FIG. 7 illustrates an example of a presence document to which an edited presence document schema is applied;

FIG. 8 is a sequence chart illustrating an example of a flow of delivering the presence document schema according to the first embodiment;

FIG. 9 is a sequence chart illustrating an example of a flow of changing the presence document schema according to the first embodiment;

FIG. 10 illustrates an example of the overall configuration of a presence information processing system according to a second embodiment of the present invention;

FIG. 11 is a schematic diagram of a data structure for describing how presence information is shared according to the second embodiment;

FIG. 12 is a sequence chart illustrating an example of a flow of editing a presence document schema according to the second embodiment;

FIG. 13 is a sequence chart illustrating an example of a flow of delivering a presence document schema according to the second embodiment;

FIG. 14 is a sequence chart illustrating an example of a flow of changing a presence document schema according to the second embodiment;

FIG. 15 schematically illustrates a presence information processing system according to a third embodiment;

FIG. 16 is a schematic diagram of a data structure for describing how presence information is shared according to the third embodiment;

FIG. 17 illustrates an example of a presence document schema;

FIG. 18 illustrates an example of a presence document schema representing presence information of people;

FIG. 19 illustrates an example of a presence document schema representing presence information of printers;

FIG. 20 illustrates an example of a presence document schema representing presence information of copiers;

FIG. 21 illustrates an example of a presence document representing presence information of people;

FIG. 22 illustrates an example of a presence document representing presence information of printers; and

FIG. 23 illustrates an example of a presence document representing presence information of copiers.

### DETAILED DESCRIPTION OF THE PREFERRED EMBODIMENTS

A description is given, with reference to the accompanying drawings, of an embodiment of the present invention.

### First Embodiment

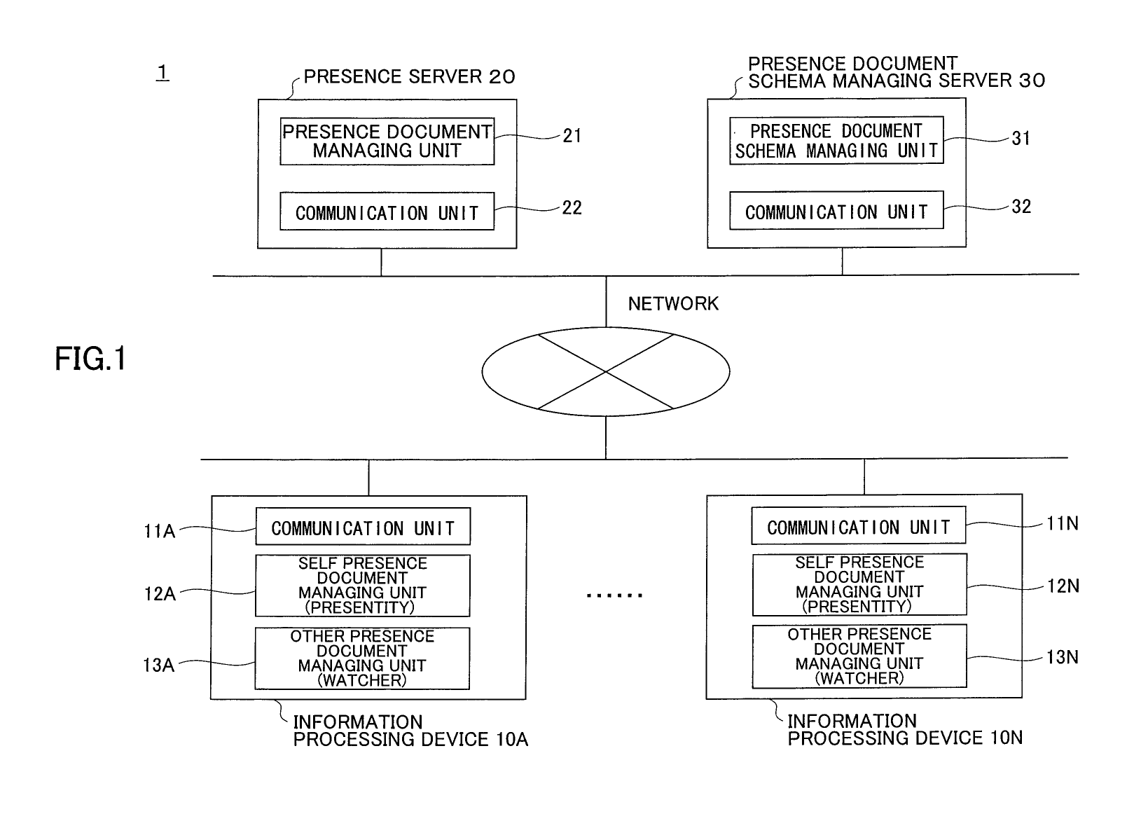

A description is given of a first embodiment of the present invention with reference to FIGS. 1 through 9.

(System Configuration)

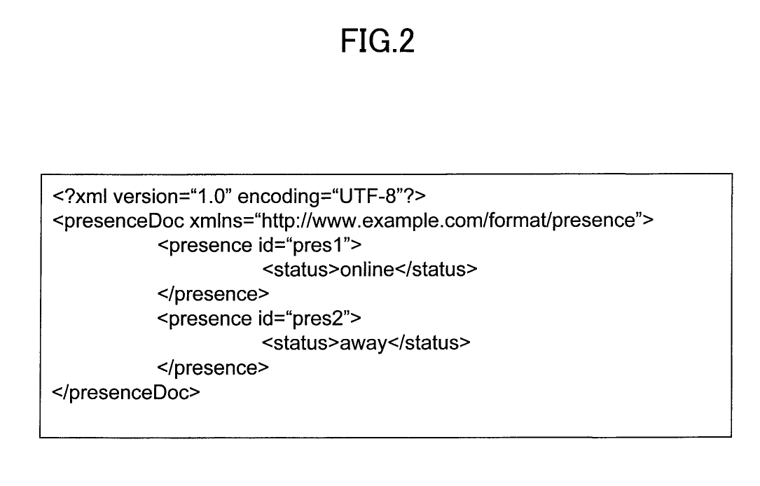

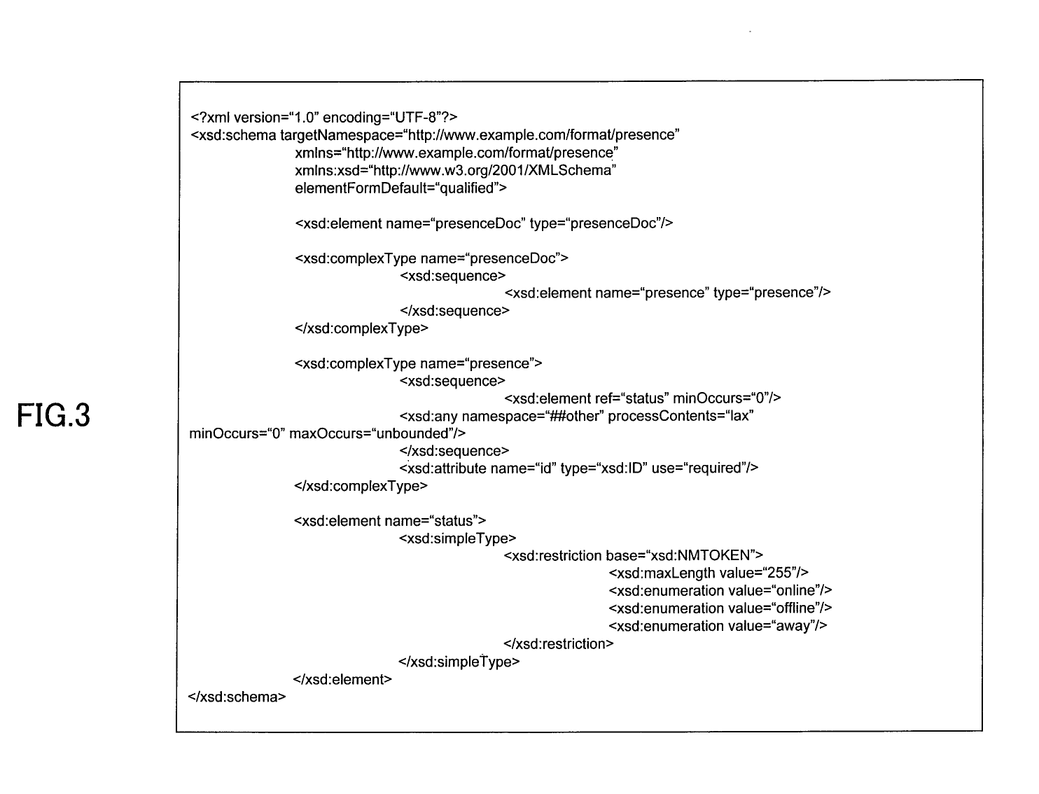

FIG. 1 illustrates an example of the overall configuration of a presence information processing system according to the first embodiment of the present invention. As shown in FIG. 1, a presence information processing system 1 includes a presence server 20, plural information processing devices 10A through 10N (hereinafter, collectively referred to as “information processing device 10”) which receive a presence service provided by the presence server 20, and a presence document schema managing server 30 for managing a presence document schema (a detailed description of a presence document schema is given with reference to FIGS. 2 and 3).

In the present embodiment, a system including the information processing device 10 and the presence server 20 is referred to as a presence system. Furthermore, a system including the information processing device 10, the presence server 20, and the presence document schema managing server 30 can be referred to as a presence document schema sharing system.

The information processing device 10 is a typical computer device, and includes a communication unit 11 (a collective reference of communication units 11A through 11N), an self presence document managing unit 12 (a collective reference of self presence document managing units 12A through 12N), and another presence document managing unit 13 (a collective reference of other presence document managing units 13A through 13N). The function of each functional unit is realized by a presence information processing program according to an embodiment of the present invention installed in the information processing device 10.

The communication unit 11 performs processes pertaining to various communication operations of the information processing device 10.

The self presence document managing unit 12 manages the presence document of the information processing device 10 in which it is included (hereinafter, “self device”). A presence document corresponds to document data including presence information such as online, off-line, or away, representing the present state of people or things as described above. Furthermore, the self presence document managing unit 12 also has a function of a client (presentity) for providing presence information of the self device to the presence service provided by the presence server 20.

The other presence document managing unit 13 manages presence documents of the information processing devices 10 other than the self device. Furthermore, the other presence document managing unit 13 also has a function of a client (watcher) for receiving presence information of another information processing device 10 from the presence service provided by the presence server 20.

According to the above configuration, the information processing device 10 acts as a presentity for providing, to another information processing device 10, presence information of the self device managed by the self presence document managing unit 12, in response to a presence information subscription request from the other information processing device 10. Furthermore, the information processing device 10 acts as a watcher for sending a presence information subscription request to another information processing device 10 and receiving presence information delivered from the other information processing device 10. That is, the information processing device 10 acts as the presentity and the watcher in a presence service provided by the presence server 20.

The presence server 20 is a typical server (computer) device, and includes a presence document managing unit 21 and a communication unit 22. The presence server 20 includes at least one server, and uniformly manages presence documents of the information processing devices 10 within the same presence information processing system 1. Plural servers can be provided for the purpose of distributing the load, but logically, the presence server 20 behaves as a single presence server. The function of each functional unit is realized by a presence server program installed in the presence server 20.

The presence document managing unit 21 uniformly manages the presence documents held by the information processing devices 10 in the presence information processing system 1.

The communication unit 22 performs processes pertaining to various communication operations of the presence server 20.

According to the above configuration, the presence server 20 receives a report of presence information from the self presence document managing unit 12 of the information processing device 10, and revises the presence information of the corresponding information processing device 10 in the presence document managing unit 21. The presence information is described in a presence document, and therefore the presence server 20 replaces the presence document of the corresponding information processing device 10 with the latest presence document. Furthermore, the presence server 20 receives a presence information subscription request from the other presence document managing unit 13, and delivers presence information to the other presence document managing unit 13 in response to the presence information subscription request. When the presence information is revised, the revised presence information is delivered to the other presence document managing unit 13.

The presence document schema managing server 30 is a typical server (computer) device, and includes a presence document schema managing unit 31 and a communication unit 32. The function of each functional unit is realized by a presence document schema managing program installed in the presence document schema managing server 30.

The presence document schema managing unit 31 holds and manages a presence document schema. Furthermore, the presence document schema managing unit 31 has a function of a schema information sharing means for having plural information processing devices 10 share the presence document schema held by the presence document schema managing unit 31. The presence document schema managing unit 31 can be included in the presence server 20. A detailed description of a presence document schema is given with reference to FIGS. 2 and 3.

The communication unit 32 performs processes pertaining to various communication operations with the information processing device 10.

According to the above configuration, the presence document schema managing server 30 is capable of collectively managing presence document schemas, thereby facilitating management.

(Presence Information, Presence Document, Presence Document Schema)

Next, a description is given of examples of presence information, a presence document, and a presence document schema, with reference to FIGS. 2 and 3.

First, a description is given of the terms. Presence information represents the present state of people and things, such as whether a user of the information processing device 10 is online, off-line, or away. A presence document is document data in which presence information is described. Plural information processing devices 10 share each other's presence information by using presence documents including presence information. A presence document schema is information representing at least one of the structure of the presence document and the vocabulary of presence information. That is, the presence document is described in accordance with the presence document schema.

The self presence document managing unit 12 of the information processing device 10 creates a presence document including presence information of the self device according to the presence document schema. Furthermore, the other presence document managing unit 13 of the information processing device 10 interprets a presence document received from the presence server 20 according to the presence document schema. Accordingly, the self presence document managing unit 12 and the other presence document managing unit 13 must use the same presence document schema.

FIG. 2 illustrates an example of a presence document. The presence document shown in FIG. 2 is described in XML (eXtensible Markup Language). FIG. 3 illustrates an example of a presence document schema. The presence document schema shown in FIG. 3 describes the presence document schema of the presence document shown in FIG. 2 with the use of XML Schema. The presence document shown in FIG. 2 can be described in a format other than XML. Furthermore, the presence document schema shown in FIG. 3 can be described in a format other than XML Schema.

In the presence document shown in FIG. 2, the presence information is described in the <presence> element. In the example shown in FIG. 2, presence information of “online” and “away” are described in the <status> element in the <presence> element. It is assumed that predefined presence information is described in the <status> element. That is, it is defined beforehand that any one of three information items of “online”, “offline”, and “away” can be described in the <status> element by default.

The presence document schema shown in FIG. 3 includes definitions pertaining to a <presence> element for describing such presence information. In the example shown in FIG. 3, an <any> element is described in an <xsd:complexType name=“presence”> element. This indicates that any element other than the <status> element can be inserted in the <presence> element of the present document, so that the presence information can be freely described. That is, any presence information can be described, other than the presence information such as “online”, “offline”, and “away” that are defined beforehand. In this manner, the presence document schema defines at least one of the vocabulary of presence information and the structure of the presence document in which the presence information is described.

(Example of Sharing Presence Information)

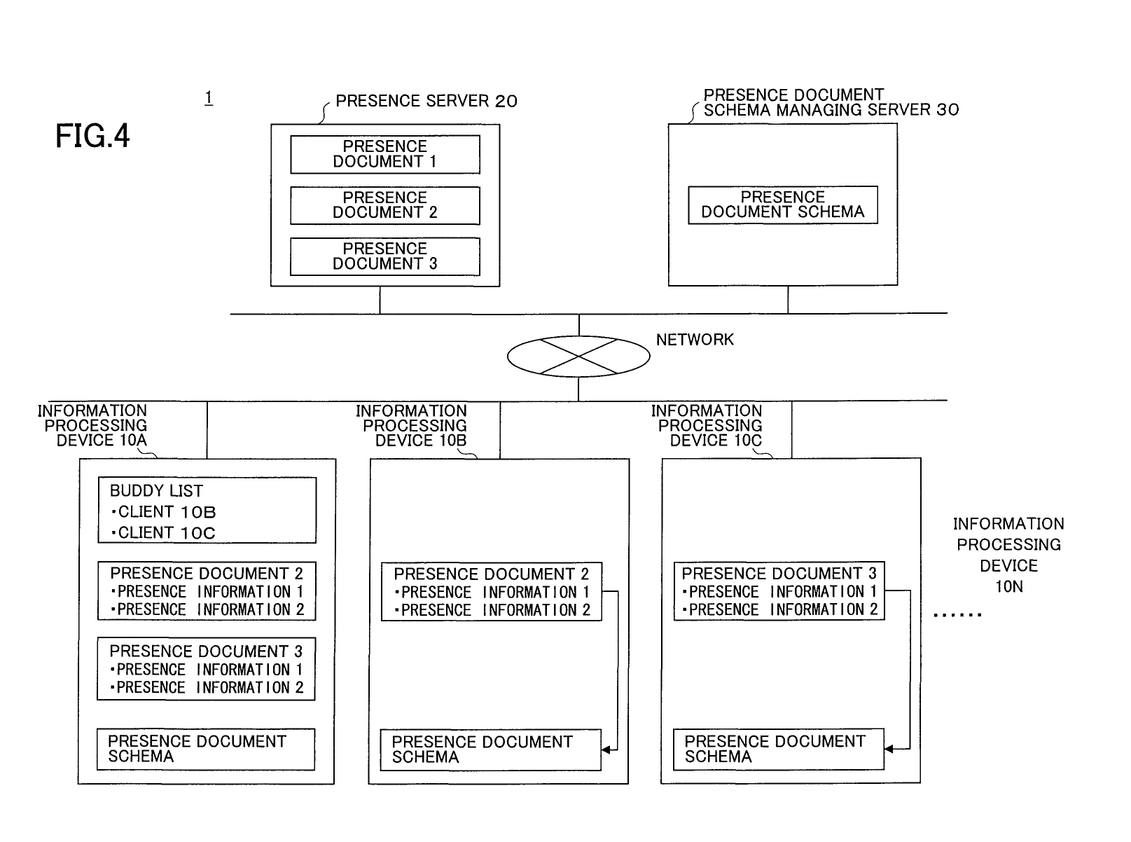

FIG. 4 is a schematic diagram of the data structure for describing how presence information is shared according to the first embodiment. In this example, the information processing device 10A that is participating in the presence information processing system 1 receives presence information provided from the information processing device 10B and the information processing device 10C. The operation of sharing the presence information in the presence information processing system 1 is described with reference to the internal data structure of the information processing device 10A.

FIG. 4 illustrates the internal data structure of when the information processing device 10A has acquired the presence documents of the information processing device 10B and the information processing device 10C.

First, it is assumed that a list of image processing devices (in this example, the information processing device 10B and the information processing device 10C), which are the sources providing the presence information to be acquired, is stored beforehand in the storage device of the information processing device 10A as a buddy list (presentity list).

When the information processing device 10A participates in the presence information processing system 1, the information processing device 10A acquires a presence document schema as shown in FIG. 3 from the presence document schema managing server 30.

Next, in accordance with the presence document schema, the information processing device 10A creates a presence document based on the presence information of the self device, and sends the presence document to the presence server 20. Furthermore, the information processing device 10A calls the buddy list stored in the storage device, and sends, to the presence server 20, a presence document subscription request for subscribing presence documents of the buddies in the buddy list. In response to the presence document subscription request received from the information processing device 10A, the presence server 20 delivers, to the information processing device 10A, presence documents (in this example, the presence documents of the information processing device 10B and the information processing device 10C).

The information processing device 10A, which has received the delivered presence documents, interprets the presence documents based on the presence document schema acquired from the presence document schema managing server 30, and presents the presence information of the buddies to the user.

As described above, the information processing device 10A that has participated in the presence information processing system 1 displays, on a display device of the self device, the presence information provided by the information processing device 10B and the information processing device 10C. Accordingly, the presence information can be shared in the presence information processing system 1.

Furthermore, the information processing device 10A that has newly participated in the presence information processing system 1 can immediately share the presence document schema, and therefore the information processing device 10A in the presence information processing system 1 can always share the latest presence document schema.

(Editing Presence Document Schema)

Next, a description is given of an example of editing the presence document schema. The presence document schema described above is managed by the presence document schema managing server 30, and can be edited only by privileged users. The editing can be allowed for the entire presence document schema or for only specific elements, such as adding/changing/deleting predetermined presence information. By limiting the editors of the presence document schema in this manner, it is possible to prevent the presence document schema from being tampered with. Furthermore, by managing the presence document schema in the presence document schema managing server 30, the operation authorization can be easily managed.

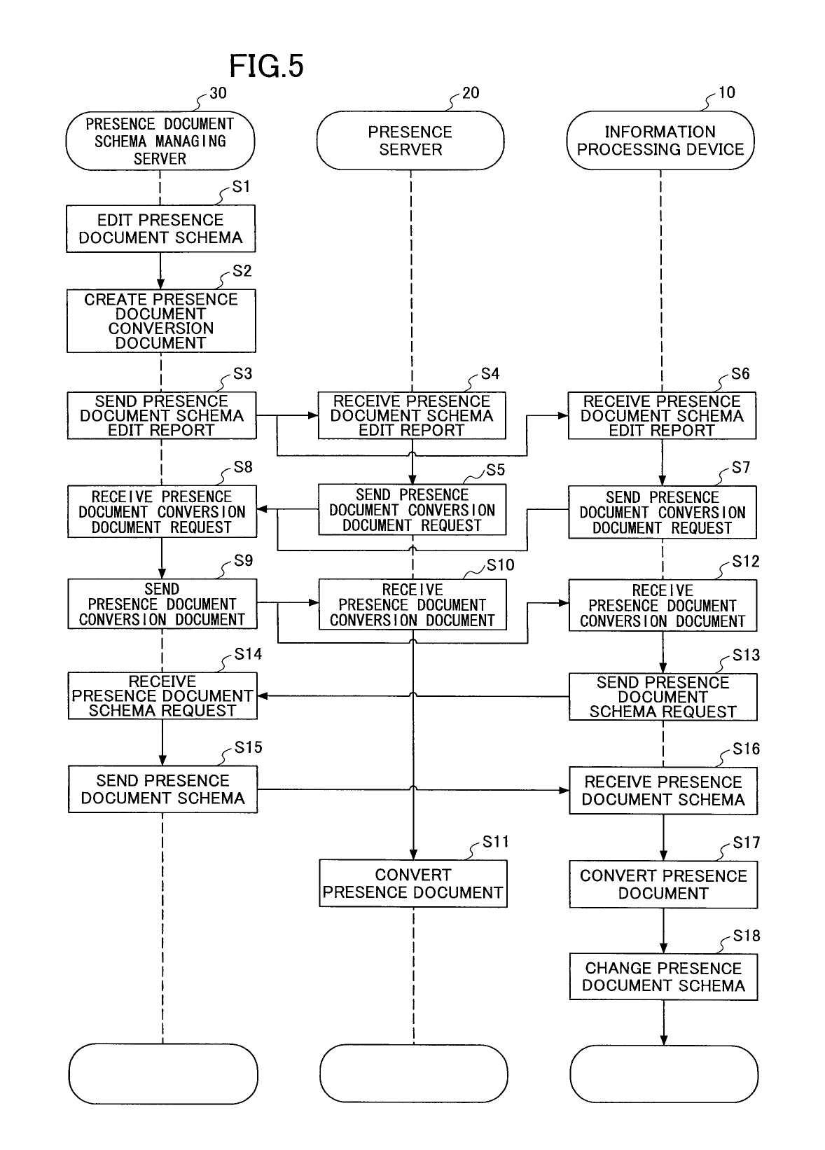

FIG. 5 is a sequence chart illustrating an example of a flow of editing the presence document schema according to the first embodiment. The presence document schema shown in FIG. 3 is taken as an example for describing the operation of editing a presence document schema. In this presence document schema, the three information items of “online”, “offline”, and “away” are defined beforehand as the presence information. This example considers a case of changing “away” to “busy”. Incidentally, it is assumed that “away” and “busy” have the same meaning.

First, the presence document schema managing server 30 edits the presence document schema (step S1). In this example, the presence document schema in the presence document schema managing server 30 is edited by a privileged user that has logged into the presence document schema managing server 30.

In step S2, the presence document schema managing server 30 creates a presence document conversion document (step S2). In this step, the presence document schema managing server 30 creates the presence document conversion document in accordance with the presence document schema edited in step S1. A description is given of the presence document conversion document.

It is possible to distribute the (edited) presence document schema which has been edited with the process of step S1, to the information processing device 10 in the presence information processing system 1, and force the information processing device 10 to reset/report the presence information in the information processing device 10 according to the presence document schema that has been edited. However, in this case, the following problems may arise. That is, the information processing device 10 may not be able to automatically reset the presence information in an appropriate manner, or the user may be forced to change the presence information. To address these problems, a document for converting the presence document is prepared, with which the presence document can be converted in such a manner as to comply with the edited presence document schema. In accordance with conversion rules described in this presence document conversion document, the presence documents in the presence server 20 and the information processing device 10 are automatically converted. Accordingly, the above problem can be solved. Even in an environment where the presence document conversion document cannot be applied, changes in the presence document schema can be reflected in the presence documents. Furthermore, the changes in the presence document schema can be directly reflected in the presence document. Therefore, when a certain information processing device needs to change a presence document of another information processing device held in the certain information processing device, it is not necessary for the certain information processing device to request a presence document from the other information processing device.

In step S3, the presence document schema managing server 30 sends a presence document schema edit report to at least one of the presence server 20 and the information processing device 10 (step S3). In this step, the presence document schema managing server 30 reports that the presence document schema has been edited, to at least one of the presence server 20 and the information processing device 10 in the presence information processing system 1. The report may include a notification that the presence document conversion document has been created with the process of step S2.

The flow proceeds from step S3 to step S4, where the presence server 20 receives the presence document schema edit report sent in step S3 (step S4). Subsequently, in step S5, the presence server 20 sends a presence document conversion document request to the presence document schema managing server 30 (step S5). Accordingly, the presence server 20 acquires, from the presence document schema managing server 30, the presence document conversion document created in step S2.

The flow proceeds from step S3 to step S6, where the information processing device 10 receives the presence document schema edit report sent in step S3 (step S6). Subsequently, the flow proceeds to step S7, where the information processing device 10 sends a presence document conversion document request to the presence document schema managing server 30 (step S7). Accordingly, the information processing device 10 acquires, from the presence document schema managing server 30, the presence document conversion document created in step S2.

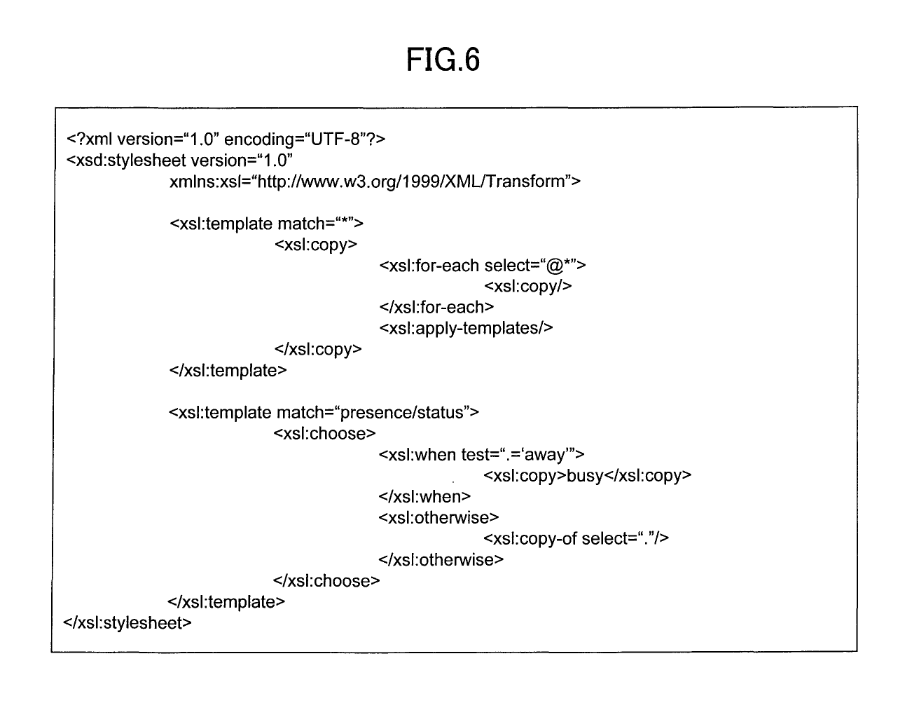

The flow proceeds to step S8, where the presence document schema managing server 30 receives the presence document conversion document request sent in at least one of steps S5 and S7 (step S8). Subsequently, the flow proceeds to step S9, where the presence document schema managing server 30 sends the presence document conversion document created in step S2 to at least one of the presence server 20 and the information processing device 10 (step S9). FIG. 6 illustrates an example of a presence document conversion document. The presence document conversion document shown in FIG. 6 is described with the use of XSLT (XSL Transform). It is possible to facilitate the operation of automatically creating the presence document conversion document shown in FIG. 6, by defining beforehand the range in which the presence document schema can be edited.

The flow proceeds from step S9 to step S10, where the presence server 20 receives the presence document conversion document sent in step S9 (step S10).

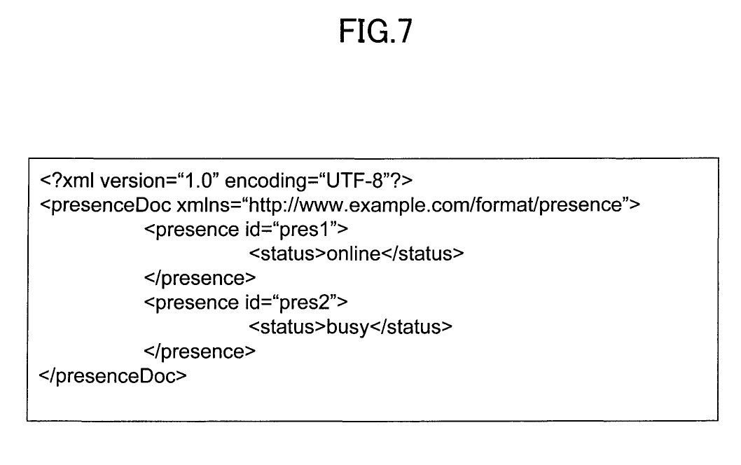

Subsequently, the flow proceeds to step S11, where the presence server 20 converts the presence documents (step S11). In this step, the presence documents of the information processing devices 10 held by the presence server 20 are converted, with the use of the presence document conversion document received in step S10. FIG. 7 illustrates the results obtained by converting the presence document shown in FIG. 2 with the use of the presence document conversion document shown in FIG. 6. Specifically, the presence document shown in FIG. 7 can be achieved by processing the presence document shown in FIG. 2 and the presence document conversion document shown in FIG. 6 with the use of an XSLT processor.

The flow proceeds from step S9 to step S12, where the information processing device 10 receives the presence document conversion document sent in step S9 (step S12). Subsequently, the flow proceeds to step S13, where the information processing device 10 sends a presence document schema request to the presence document schema managing server 30 (step S13). Accordingly, the information processing device 10 acquires the presence document schema converted with the process of step S1.

The flow proceeds to step S14, where the presence document schema managing server 30 receives the presence document schema request sent in step S13 (step S14). Subsequently, the flow proceeds to step S15, where the presence document schema managing server 30 sends the edited presence document schema to the information processing device 10 (step S15).

The flow proceeds to step S16, where the information processing device 10 receives the presence document schema sent in step S15 (step S16). Accordingly, the information processing device 10 acquires, from the presence document schema managing server 30, the edited presence document schema and the presence document conversion document.

Subsequently, in step S17, the information processing device 10 converts the presence document (step S17). In this step, the presence document is converted in the same manner as the process of step S11. Accordingly, the presence document of the self device as well as the presence documents of the buddies held by the self device are converted.

The flow proceeds to step S18, where the information processing device 10 changes the presence document schema (step S18). With the process of step S18, the presence document schema to be used is changed to the edited presence document schema. The presence document schema before being edited can be saved as a backup.

The operation of editing the presence document schema is performed with the processes described above. By editing the presence document schema in the above manner, the presence document can be freely extended.

In the above example, a case of changing “away” to “busy” is considered. However, a process of deleting “away” from the three predefined presence information items can also be performed by creating a presence document conversion document in the same manner. In a case of adding a new presence information item “busy” to the three predefined presence information items, there is no such state as “busy” in the existing presence document, and therefore there is no need to create a presence document conversion document. In any of the cases of changing, deleting, or adding an item, the information processing device 10 that has received the presence document schema edit report preferably presents to the user the portion that has been edited.

Furthermore, when the presence document schema managing server 30 sends out the presence document schema edit report with the process of step S3, there may be cases where the information processing device 10 does not receive this report because of being temporarily offline, for example. This problem can be solved by having the presence document schema managing server 30 periodically report the state of the presence document schema, or by having the information processing device 10 periodically monitor the state of the presence document schema. Alternatively, the problem can be solved by using the mechanism of presence document delivery of the presence information processing system, to suppress the increase in traffic.

Furthermore, in the process of step S15, the presence document schema managing server 30 can deliver only the edited portion, and the information processing device 10 can apply this edited portion only to the portion to be changed, to attain the edited presence document schema. By sending only the edited portion of the presence document schema, it is possible to decrease the amount of data to be sent, and effectively reflect the edited portion in the presence document schema.

(Delivery of Presence Document Schema)

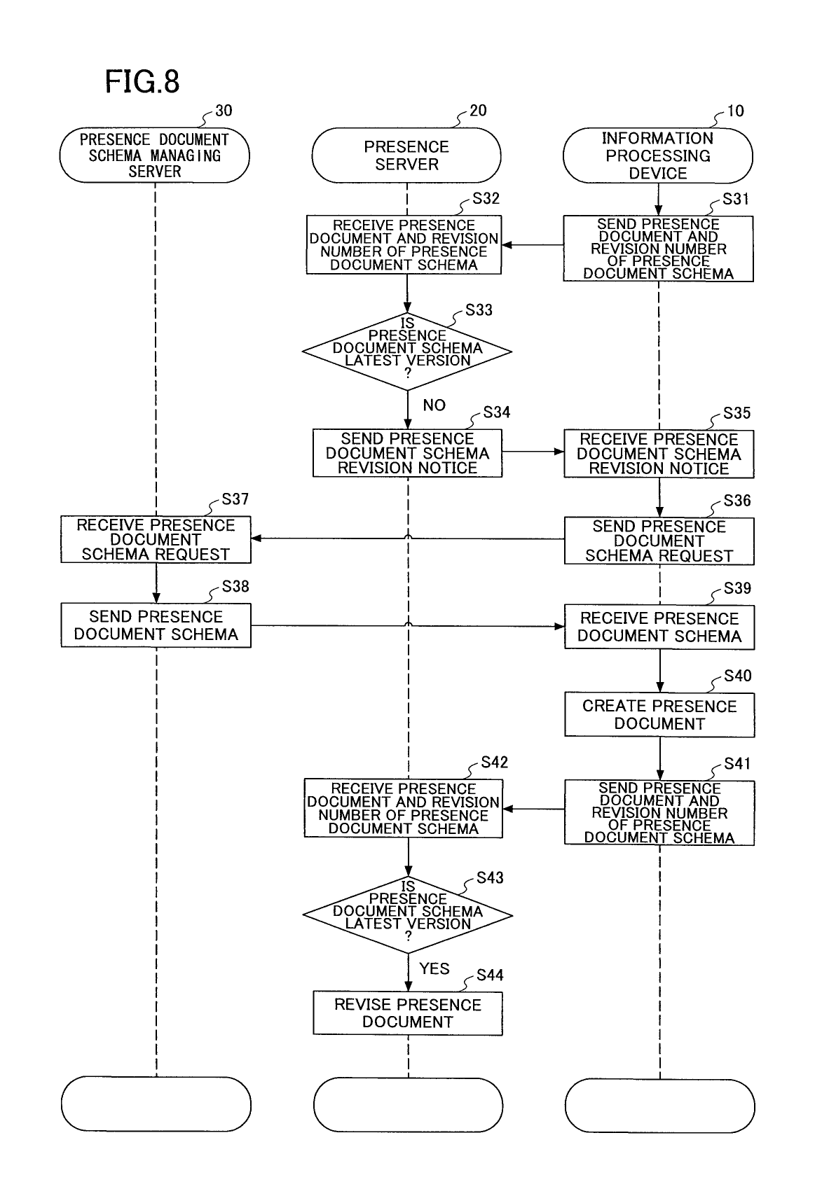

Next, a description is given of an example of delivering the presence document schema. FIG. 8 is a sequence chart illustrating an example of a flow of delivering the presence document schema according to the first embodiment. A description is given of an example of delivering the latest presence document schema based on the revision number of the presence document schema.

First, the information processing device 10 sends, to the presence server 20, a presence document and a revision number of the presence document schema (step S31). In this step, the information processing device 10 sends, to the presence server 20, the presence document together with the revision number of the presence document schema. The revision number can be included in the presence document, or included in a presence document transmission message. Furthermore, the revision number can be managed by the presence document schema managing server 30 or managed by the presence server 20.

Subsequently, the flow proceeds to step S32, where the presence server 20 receives the presence document and the revision number of the presence document schema (step S32).

The flow proceeds to step S33, where the presence server 20 determines whether the schema of the presence document received in step S32 is the latest version (step S33). This step is performed by comparing the revision number of the presence document schema received in step S32 with the revision number of the latest presence document schema held in the self device.

In step S33, when the presence server 20 determines that the schema is the latest version (Yes in step S33), it means that the presence document received from the information processing device 10 complies with the latest presence document schema, and therefore the process ends. However, the process performed in the case of YES in step S44 described below can be performed. In step S33, when the presence server 20 determines that the schema is not the latest version (No in step S33), it means that the presence document received from the information processing device 10 does not comply with the latest presence document schema, and therefore the presence server 20 acquires the latest presence document schema by the processes performed from step S34 onward.

The flow proceeds to step S34, where the presence server 20 sends a presence document schema revision notice to the information processing device 10 (step S34). When the presence server 20 determines that the schema of the presence document received in step S32 is not the latest version, the presence server 20 reports this to the information processing device 10. Subsequently, the flow proceeds to step S35, where the information processing device 10 receives the presence document schema revision notice sent in step S34 (step S35).

The flow proceeds to step S36, where the information processing device 10 sends a presence document schema request to the presence document schema managing server 30 (step S36). Subsequently, the flow proceeds to step S37, where the presence document schema managing server 30 receives the presence document schema request sent in step S36 (step S37).

The flow proceeds to step S38, where the presence document schema managing server 30 sends the presence document schema to the information processing device 10 (step S38). In this step, the latest presence document schema managed by the presence document schema managing server 30 is sent. Subsequently, the flow proceeds to step S39, where the information processing device 10 receives the latest presence document schema sent in step S38 (step S39).

Subsequently, the flow proceeds to step S40, where the information processing device 10 creates a presence document (step S40). In this step, the presence document is created with the use of the latest presence document schema received in step S39.

Subsequently, the flow proceeds to step S41, where the information processing device 10 sends, to the presence server 20, the presence document and the revision number of the presence document schema (step S41). In this step, the information processing device 10, which has revised the presence document schema to the latest version by the above processes, sends the presence document to the presence server 20 once again. Furthermore, the flow proceeds to step S42, where the presence server 20 receives the presence document and the revision number of the presence document schema sent in step S41 (step S42).

The flow proceeds to step S43, where the presence server 20 determines whether the schema of the presence document received in step S42 is the latest version (step S43). This step is performed by comparing the revision number of the presence document schema received in step S42 with the revision number of the latest presence document schema held in the self device.

In step S43, when the presence server 20 determines that the schema is the latest version (Yes in step S43), it means that the presence document received from the information processing device 10 complies with the latest presence document schema, and therefore the flow proceeds to step S44, where the presence server 20 revises the corresponding presence document to the latest presence document (step S44).

In step S43, when the presence server 20 determines that the schema is not the latest version (No in step S43), it means that the presence document received from the information processing device 10 does not comply with the latest presence document schema, and therefore the process ends. However, the process performed in the case of NO in step S33 can be performed.

By performing the above processes, the presence information processing system 1 performs the operation of delivering the latest presence document schema based on the revision number of the presence document schema. Particularly, as the revision numbers of the presence document schemas are being managed, it can be easily determined as to whether the presence document schema presently being used by the information processing device is the same as the presence document schema presently being shared in the network.

When the presence server 20 delivers the presence document, the status of the presence document schema can be reported to the information processing device 10 by including the revision number of the presence document schema in the presence document. However, to perform this method, the presence server 20 needs to be provided with such a function. When the presence server 20 does not have this function, the information processing device 10 includes the revision number of the presence document schema in the presence document, and delivers the presence document. The information processing device 10 that receives this presence document compares the revision number of the presence document schema of the self device with the revision number included in the received document. If the schema of the self device is older, the schema is revised, and if the schema of the received document is older, an instruction is given to revise the schema. When the presence server 20 is not used, the transmission source information processing device 10 and the transmission destination information processing device 10 are both likely to not hold the latest presence document schema. In this case, the method of periodically confirming the state of the schema needs to be performed in as well.

Furthermore, the presence document schema managing server 30 can have a function of creating a new presence document schema. Such a presence document schema creating function is utilized for the purpose of improving the extendibility of the presence information description. Only privileged users can access such a presence document schema creating unit. A privileged user may refer to a template of a presence document schema, or create a new presence document schema from the beginning. Alternatively, the user can upload an existing presence document schema and add it to the system. For example, by adding a presence document schema of another presence information processing system to the present system, the present system can be extended. After the new presence document schema has been created, the privileged user gives a presence document schema changing instruction, so that the new presence document schema is employed in the presence information processing system 1.

When presence document schemas are created, added, and corrected several times, the system may include an excessive number of presence document schemas. In such a case, the presence document schema managing server 30 can send a deletion notice to the information processing device 10, to delete a presence document schema. However, it is not possible to delete a presence document schema that is presently being used. To delete a presence document schema that is presently being used, the presence document schema presently being used is changed to another one with a presence document schema changing unit described below, and then a deletion notice is sent. In this manner, when another presence document schema has been added, and therefore a certain presence document schema becomes unnecessary, this certain presence document schema can be deleted.

(Changing Presence Document Schema)

Next, a description is given of an example of changing the presence document schema. As described above, when a new presence document schema has been created or the presence document schema managing server 30 is managing plural presence document schemas and the user desires to change the presence document schema to one that is different from that presently being used, the presence document schema managing server 30 can give a presence document schema changing instruction.

When a presence document schema changing instruction is given, it is preferable to create a presence document conversion document for converting the presence document complying with the presence document schema presently being used into a presence document complying with the presence document schema that is to become the presently used one. If the presence document conversion document is created, a presence document and a presence document schema can be changed by the same method performed for editing the presence document schema. However, there may be cases where the presence document conversion document cannot be applied when the presence document schema is edited or when a new presence document schema is created. For example, the presence document conversion document cannot be applied when the presence document structure has been considerably changed, when there is no interrelationship in the meaning of the presence information before being changed and after being changed, and/or when the presence server 20 does not have a function of applying the presence document conversion document. In such a case, the presence document schema after being changed is distributed to the information processing device 10 in the presence information processing system 1, and the information processing device 10 is forced to reset/report the presence information. Similar processes are performed to address this problem also when the presence document schema has been edited but the presence document conversion document cannot be applied. Accordingly, a mechanism of presence document delivery is used to deliver the presence document schema to the presentity or the watcher. Furthermore, the same process can be performed to address a case where the presence document schema cannot be revised at the presentity or the watcher for some reason.

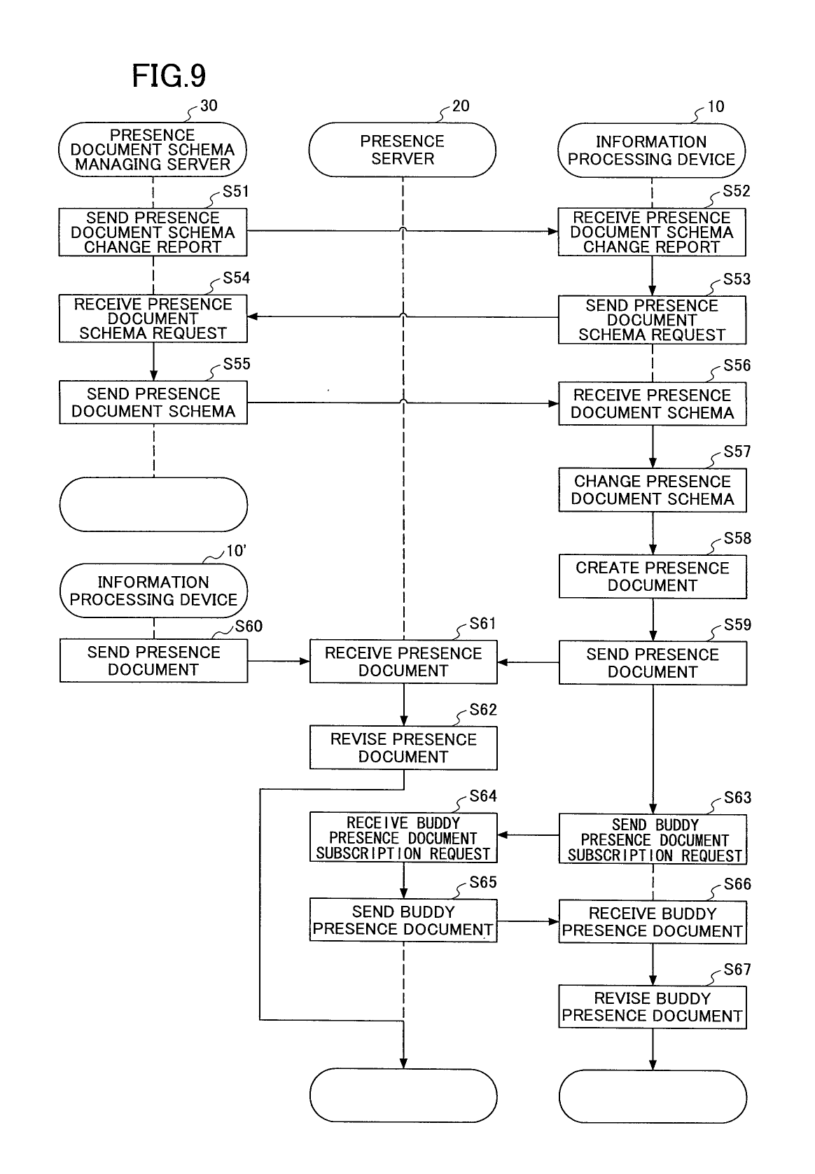

FIG. 9 is a sequence chart illustrating an example of a flow of changing the presence document schema according to the first embodiment. A description is given of the flow of changing the presence document schema when the presence document conversion document cannot be applied.

First, the presence document schema managing server 30 sends a presence document schema change report to the information processing device 10 (step S51). Specifically, the presence document schema managing server 30 that has received a presence document schema change instruction reports to the information processing device 10 in the presence information processing system 1 that the presence document schema has been changed to another one (changed presence document schema). There is a description in the presence document schema change report that there is no presence document conversion document. Subsequently, the flow proceeds to step S52, where the information processing device 10 receives the presence document schema change report sent in step S51 (step S52).

The flow proceeds to step S53, where the information processing device 10 sends a presence document schema request to the presence document schema managing server 30 (step S53). By this process, the information processing device 10 acquires the changed presence document schema from the presence document schema managing server 30. Subsequently, the flow proceeds to step S54, where the presence document schema managing server 30 receives the presence document schema request sent in step S53 (step S54).

The flow proceeds to step S55, where the presence document schema managing server 30 sends the changed presence document schema to the information processing device 10 (step S55). Subsequently, the flow proceeds to step S56, where the information processing device 10 receives the changed presence document schema sent in step S55 (step S56).

Subsequently, the flow proceeds to step S57, where the information processing device 10 changes the presence document schema (step S57). Accordingly, the information processing device 10 that received the presence document schema change report by the process of step S52 acquires the changed presence document schema from the presence document schema managing server 30, and changes the presence document schema to be used to the one received in step S56. The presence document schema before being changed can be saved as a backup.

Subsequently, the flow proceeds to step S58, where the information processing device 10 creates a presence document (step S58). In this step, the presence document is created in accordance with the changed presence document schema received by the process of step S56.

Subsequently, the flow proceeds to step S59, where the information processing device 10 sends the presence document created in step S58 to the presence server 20 (step S59). In this step, the information processing device 10 can prompt the user to input presence information according to need (step S59).

In step S60, assuming that the subject information processing device 10 is the watcher, a different information processing device 10 corresponding to a presentity sends a presence document being managed by the self device to the presence server 20 (step S60). It is assumed that at least one of a presence document complying with the changed presence document schema and a presence document not complying with the changed presence document schema is sent in step S60.

The flow proceeds from step S59 to step S61, where the presence server 20 receives at least one of the presence document sent in step S59 and the presence document sent in step S60 (step S61). In this step, the presence server 20 receives the presence document created in accordance with the changed presence document schema and the presence document not created in accordance with the changed presence document schema.

Subsequently, the flow proceeds to step S62, where the presence server 20 revises the presence documents corresponding to the ones received in step S61 (step S62). In this step, the presence server 20 revises the presence documents managed by the self device to the presence documents received in step S61.

The flow proceeds from step S59 to step S63, where the information processing device 10 sends a buddy (presentity) presence document subscription request to the presence server 20 (step S63). The process of step S63 can be performed at the same time as the process of step S60. Subsequently, the flow proceeds to step S64, where the presence server 20 receives the buddy presence document subscription request sent in step S63 (step S64).

Subsequently, the flow proceeds to step S65, where the presence server 20 sends a buddy presence document to the information processing device 10 (step S65). In this step, the presence server 20 sends the presence document of the buddy in response to the buddy presence document subscription request received in step S64. The flow proceeds to step S66, where the information processing device 10 receives the buddy presence document sent in step S65 (step S66).

Subsequently, the flow proceeds to step S67, where the information processing device 10 revises the buddy presence document (step S67). In this step, the information processing device 10 that has received the presence document of the buddy interprets the received presence document with the use of the changed presence document schema. When the received buddy presence document complies with the presence document schema before being changed, the information processing device 10 can perform the processes of interpreting the presence document in accordance with the presence document schema before being changed and repeatedly sending the subscription request until a presence document complying with the changed presence document schema is sent, or sending the changed presence document schema to the corresponding buddy. Furthermore, the information processing device 10 that has received the presence document schema change report can present this to the user.

By the above-described processes, the presence information processing system 1 can change the presence document schema even when a presence document conversion document cannot be applied. Thus, even in an environment where the presence document conversion document cannot be applied, changes in the presence document schema can be reflected in the presence document. Furthermore, by changing the presence document schema in this manner, it is possible to select a presence document schema to be actually used from the plural presence document schemas being shared.

When the presence document schema managing server 30 sends the presence document schema change report by the process of step S51, and the client does not receive this report because of being temporarily offline, etc., it is possible to perform the same process as that for editing the presence document schema.

### Second Embodiment

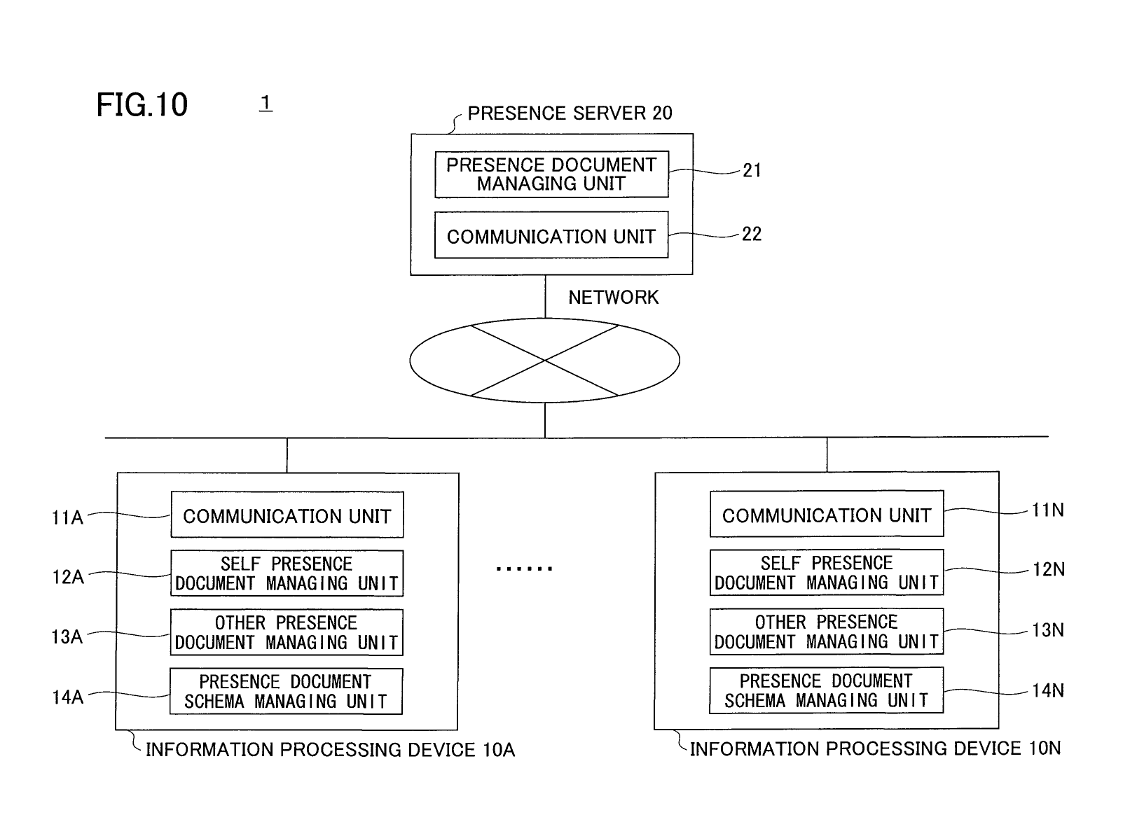

A description is given of a second embodiment of the present invention with reference to FIGS. 10 through 14.

(System Configuration)

FIG. 10 illustrates an example of the overall configuration of a presence information processing system according to the second embodiment of the present invention. As shown in FIG. 10, the presence information processing system 1 includes the presence server 20 and the plural information processing devices 10A through 10N (hereinafter, collectively referred to as “information processing device 10”) for receiving a presence service provided by the presence server 20.

The difference between the above-described first embodiment (see FIG. 1) is that the second embodiment does not include the presence document schema managing server 30 that manages presence document schemas. The presence document schemas that are managed by the presence document schema managing server 30 in the first embodiment are managed by a presence document schema managing unit 14 of the information processing device 10 in the second embodiment, and are shared by plural information processing devices 10 in a peer-to-peer (P2P) manner. That is, each information processing device 10 is a peer, so that a P2P network is formed, thereby realizing the presence information processing system 1. Because a server for managing the presence document schemas is unnecessary, the system can be easily installed.

The presence information, the presence document, and the presence document schema used in the present embodiment are assumed to be the same as those used in the first embodiment (see FIGS. 2 and 3), and are therefore not further described.

(Example of Sharing Presence Information)

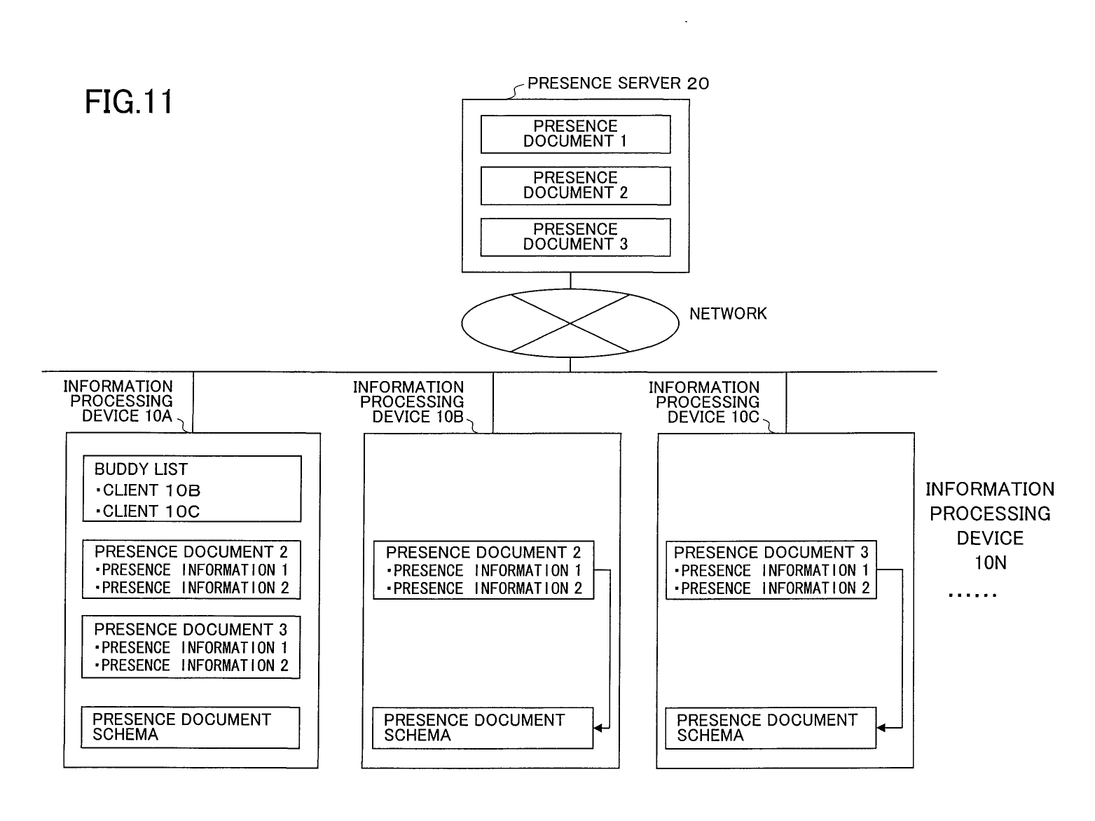

FIG. 11 is a schematic diagram of the data structure for describing how presence information is shared according to the second embodiment. In this example, the information processing device 10A that is participating in the presence information processing system 1 receives presence information provided from the information processing device 10B and the information processing device 10C. Accordingly, the presence information is shared in the presence information processing system 1.

FIG. 11 illustrates the internal data structure of when the information processing device 10A has acquired the presence documents of the information processing device 10B and the information processing device 10C. Similarly to the first embodiment described above, the presence server 20 manages the presence documents in the second embodiment. However, in another example, each information processing device 10 can manage the presence documents.

First, it is assumed that a list of image processing devices (in this example, the information processing device 10B and the information processing device 10C), which are the sources providing the presence information to be acquired, is stored beforehand in the storage device of the information processing device 10A as a buddy list (presentity list).

When the information processing device 10A participates in the presence information processing system 1, the information processing device 10A acquires a presence document schema as shown in FIG. 3 from the information processing device 10B and the information processing device 10C.

When the information processing device 10B and the information processing device 10C are not participating in the presence information processing system 1, the presence document schema is acquired from an authentication managing server (not shown), the presence server 20, or the presence document schema managing server 30 (not shown). Alternatively, the information processing device 10A can use the presence document schema held by itself. When presence document schemas can be acquired from the information processing device 10B and the information processing device 10C, the presence document schema can be acquired according to an existing P2P logic.

For example, in a P2P network that does not include the presence server 20 and is purely formed of peers only (hereinafter, such a P2P network is referred to as “Pure P2P”), a peer can acquire desired data in the following manner. For example, a peer sends, to a nearby peer, a search request to search for the desired data. When a peer that has received the search request is holding the corresponding data, this peer returns a message to this effect. The peer that receives this return message acquires the corresponding data from the peer that is holding it. When a peer that has received the search request is not holding the corresponding data, this peer transfers the search request to another peer. In this manner, the search request is transferred until it reaches a peer that is holding the corresponding data, and when it reaches such a peer, the search operation ends and the corresponding data is acquired.

When a peer has acquired the presence document schema which is the desired data by the above process, this peer creates its self presence document in accordance with the acquired presence document schema, and sends the created presence document to the presence server 20. At the same time, the peer sends a buddy presence document subscription request to the presence server 20.

The presence server 20 delivers the presence documents (in this case, the presence documents of the information processing device 10B and the information processing device 10C) to the information processing device 10A in response to the presence document subscription request from the information processing device 10A.

The information processing device 10A that has received the delivered presence documents interprets the presence documents in accordance with the presence document schema and presents the presence information of the buddies to the user.

As described above, the information processing device 10A that has participated in the presence information processing system 1 displays, on a display device of the self device, the presence information provided by the information processing device 10B and the information processing device 10C.

(Editing Presence Document Schema)

Next, a description is given of an example of editing the presence document schema. The presence document schema described above is managed by the information processing device 10, and any information processing device 10 having a presence document schema editing function can edit the presence document schema managed by the self device.

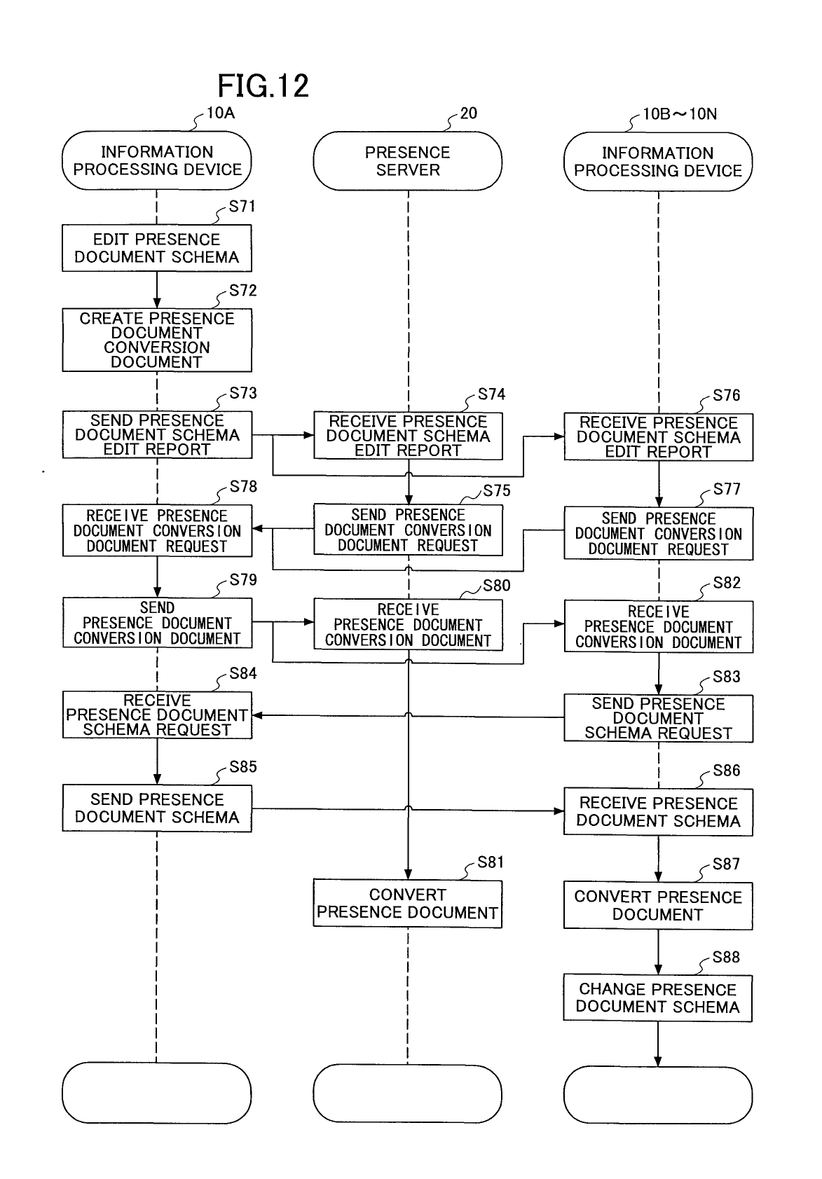

FIG. 12 is a sequence chart illustrating an example of a flow of editing the presence document schema according to the second embodiment. In the sequence chart shown in FIG. 12, the “presence document schema managing server 30” shown in the sequence chart according to the first embodiment (FIG. 5) is replaced with the “information processing device 10A”, and the “information processing device 10” shown in the sequence chart of FIG. 5 is replaced with the “information processing devices 10B through 10N”. Otherwise, the sequence chart shown in FIG. 12 is the same as that of FIG. 5, and therefore redundant descriptions are omitted. However, with respect to the process of step S73, the following supplementary descriptions are given.

In step S73, the information processing device 10A distributes, in accordance with a P2P logic, the presence document schema edited by the process of step S71 and the presence document conversion document created by the process of step S72, to the information processing devices 10B through 10N. It is possible to only distribute the edited part of the edited presence document schema.

For example, in a Pure P2P, a peer distributes the data in the following manner. The peer sends a notice on the information of the data to be distributed to a nearby peer. The peer that has received the notice transfers the notice to another peer. When a peer that has received the notices does not hold the data, this peer acquires the data from the data distribution source peer. In this manner, the notice is sent to all of the peers in the P2P network, so that the data is distributed.

By the above described process, an operation of editing the presence document schema is performed.

The presence document conversion document may not be applicable because the presence document schema has been considerably changed, there is no interrelationship in the meaning of the presence information before being changed and after being changed, or the presence server 20 does not have a function of applying the presence document conversion document. In such a case, the edited presence document schema is distributed only to the other information processing devices 10B through 10N according to the P2P logic. It is possible to only distribute the edited part of the edited presence document schema. Each of the information processing devices 10B through 10N changes the presence document schema to the edited one, and creates its self presence document in accordance with the edited presence document schema. At this step, the information processing device 10 can prompt the user to input presence information according to need. The presence document schema before being edited can be saved as a backup. Then, each of the information processing devices 10B through 10N sends the presence document to the presence server 20. Subsequently, each of the information processing devices 10B through 10N sends a buddy presence document subscription request to the presence server 20. Each of the information processing devices 10B through 10N interprets the received buddy presence document in accordance with the edited presence document schema. When the received buddy presence document complies with the presence document schema before being edited, the information processing devices 10B through 10N can perform the processes of interpreting the presence document in accordance with the presence document schema before being changed and repeatedly sending the subscription request until a presence document complying with the edited presence document schema is sent, or sending the edited presence document schema to the corresponding buddy.

Furthermore, when the information processing device 10A sends out the presence document schema edit report, there may be cases where the information processing devices 10B through 10N do not receive this report because of being temporarily offline, for example. This problem can be solved by having the information processing devices 10B through 10N periodically monitor the state of the presence document schema of information processing devices 10 other than the self device. Alternatively, the problem can be solved by using the mechanism of presence document delivery of the presence information processing system 1, to suppress the increase in traffic.

Furthermore, when only privileged users are authorized to edit the presence document schema, the delivery source of the presence document schema is limited. That is, each of the information processing devices 10B through 10N that has received the presence document schema edit report in the process of step S76 cross-checks the delivery source of the presence document schema (in this case, the information processing device 10A) and a privileged user list held therein in advance. The privileged user list is acquired beforehand from the presence server 20, or the privileged user list is shared in the P2P network. When it is determined as a result of the cross-check that the information processing device which is the delivery source of the presence document schema is a privileged user, the information processing devices 10B through 10N acquire the edited presence document schema from the information processing device 10A.

When presence document schemas are created, added, and corrected several times, the system may include an excessive number of presence document schemas. In such a case, the information processing devices 10B through 10N can send deletion notices to the information processing device 10A, to delete a presence document schema. However, it is not possible to delete a presence document schema that is presently being used. To delete a presence document schema that is presently being used, the presence document schema presently being used is to be changed to another one with a presence document schema changing unit described below, and then a deletion notice is to be sent.

(Delivery of Presence Document Schema)

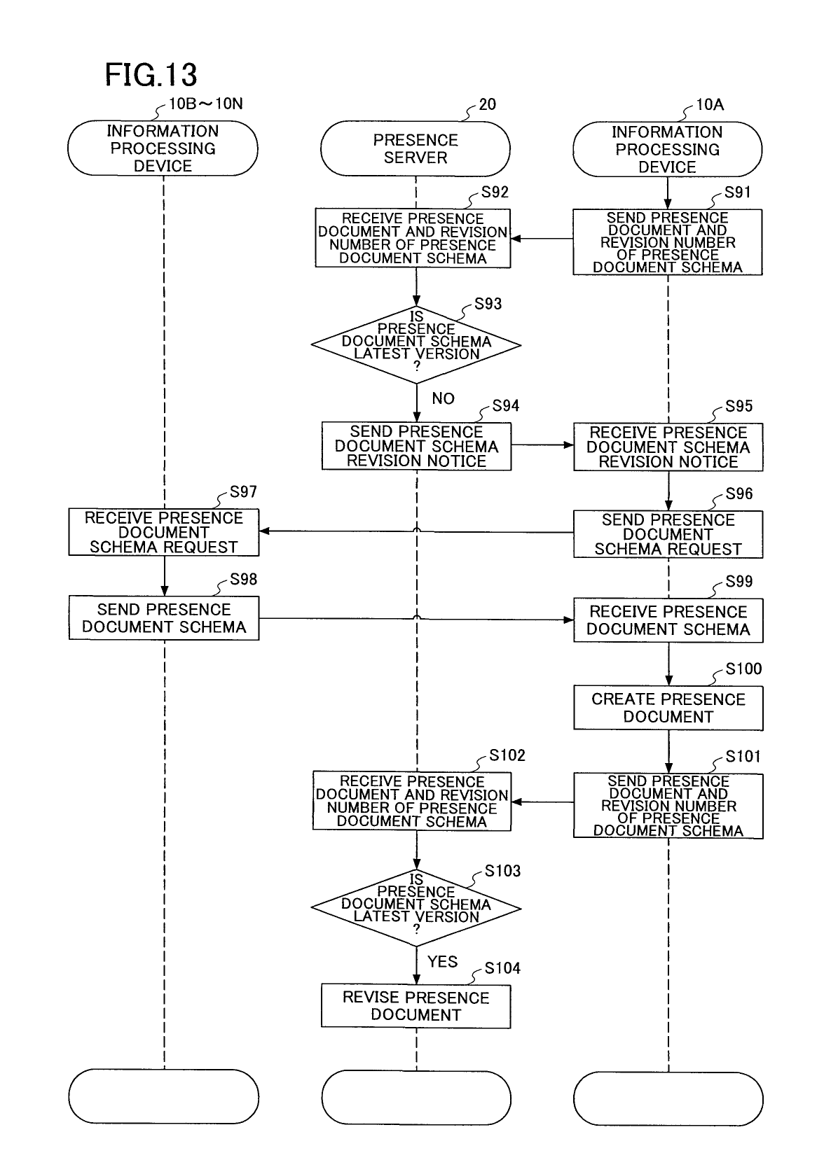

Next, a description is given of an example of delivering the latest presence document schema. FIG. 13 is a sequence chart illustrating an example of a flow of delivering the presence document schema according to the second embodiment. A description is given of an example of delivering the latest presence document schema based on the revision number of the presence document schema.

In the sequence chart shown in FIG. 13, the “information processing device 10” shown in the sequence chart according to the first embodiment (FIG. 8) is replaced with the “information processing device 10A”, and the “presence document schema managing server 30” shown in the sequence chart of FIG. 8 is replaced with the “(one or more of the) information processing devices 10B through 10N”. Otherwise, the sequence chart shown in FIG. 13 is the same as that of FIG. 8, and therefore redundant descriptions are omitted. However, with respect to the process of step S91, the following supplementary descriptions are given.

In step S91, the information processing device 10A sends, to the presence server 20, a presence document and a revision number of the presence document schema (step S91). The revision number of the presence document schema is shared and managed among the information processing devices 10 in the P2P network.

(Changing Presence Document Schema)

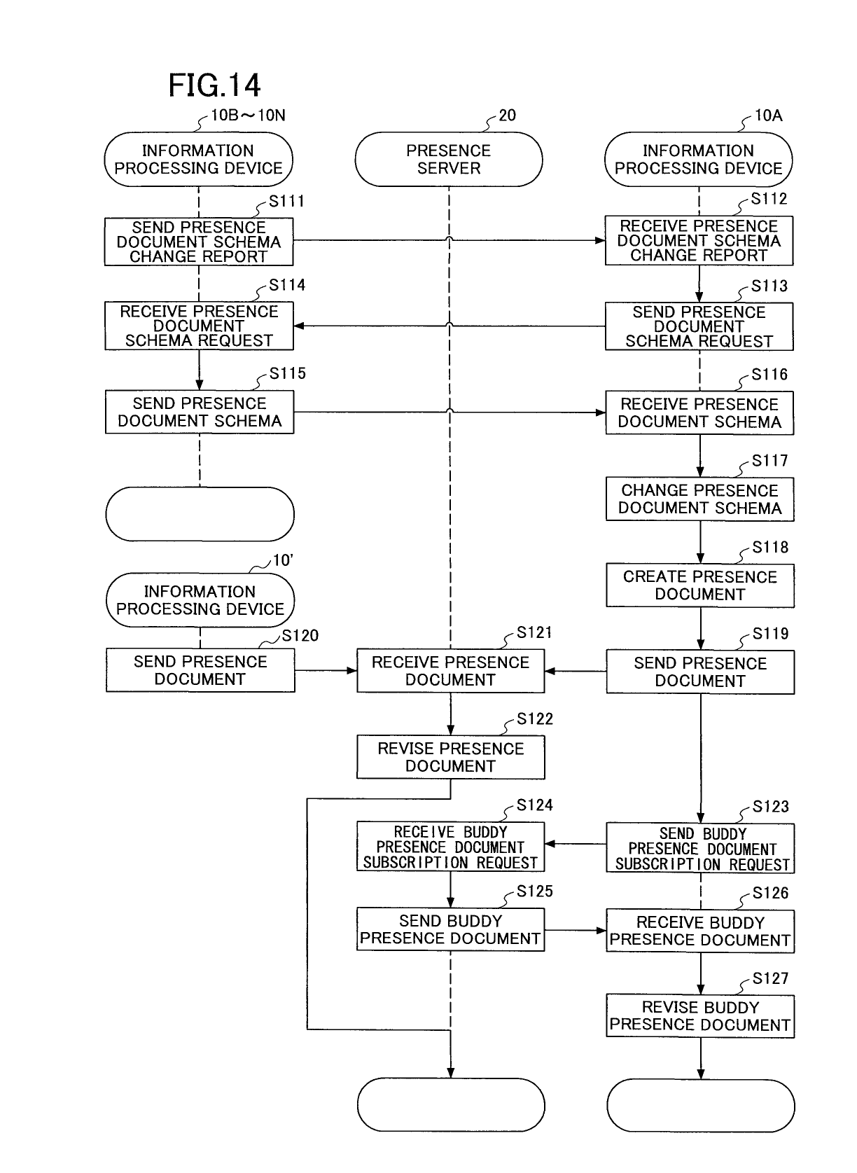

Next, a description is given of an example of changing the presence document schema. FIG. 14 is a sequence chart illustrating an example of a flow of changing the presence document schema according to the second embodiment. A description is given of the flow of changing the presence document schema when the presence document conversion document cannot be applied.

In the sequence chart shown in FIG. 14, the “information processing device 10” shown in the sequence chart according to the first embodiment (FIG. 9) is replaced with the “information processing device 10A”, and the “presence document schema managing server 30” shown in the sequence chart of FIG. 9 is replaced with the “(one or more of the) information processing devices 10B through 10N”. Otherwise, the sequence chart shown in FIG. 14 is the same as that of FIG. 9, and therefore redundant descriptions are omitted.

### Third Embodiment

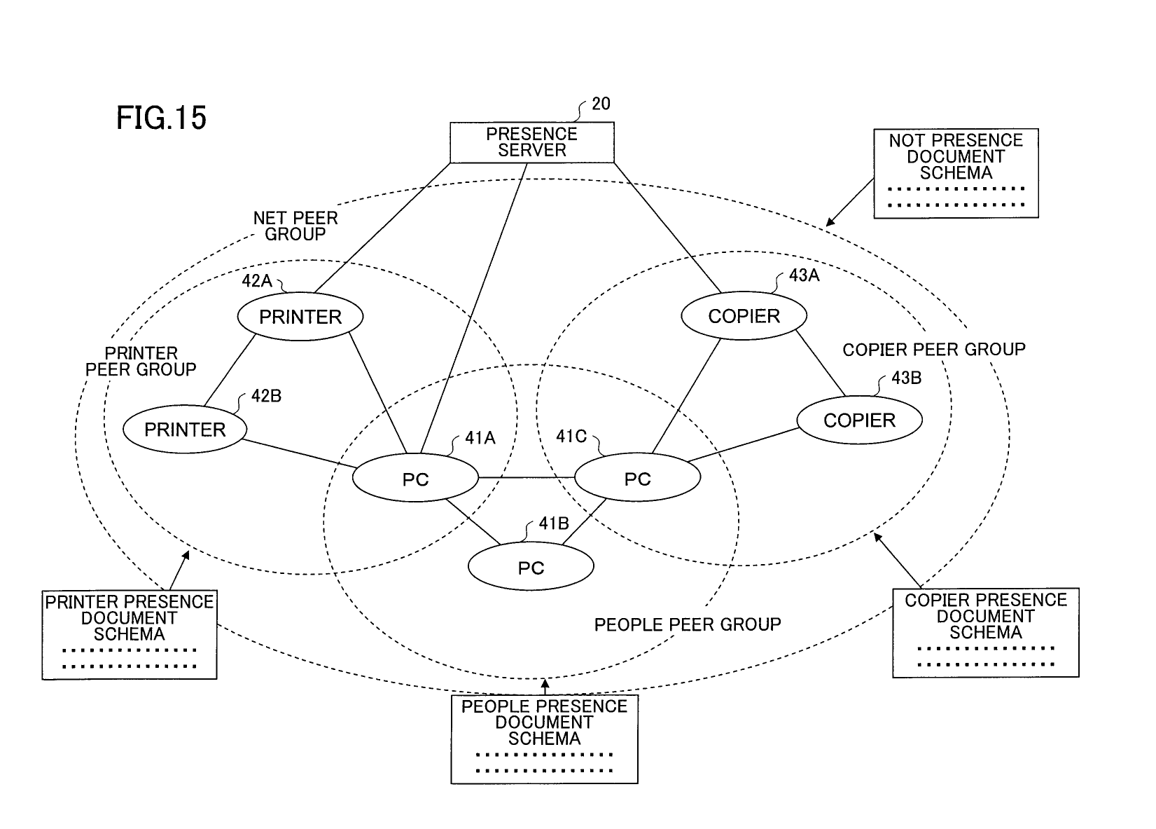

A description is given of a third embodiment of the present invention with reference to FIGS. 15 through 23.

The presence information processing systems according to the first and second embodiments and the conventional technology do not consider the cases of sharing different types of presence document schemas or dynamically changing the scope of the presence document schemas to be shared. Thus, only one type of presence information can be handled by each presence information processing system. For example, presence information of people and presence information of printers cannot be handled by a single presence information processing system.

In this embodiment, plural types of presence document schemas are shared in a single presence information processing system, so that a single application can interpret plural types of presence information. Accordingly, the optimum presence document schema can be selected according to need. Furthermore, information processing devices that use different kinds of presence information can be connected to each other within the same presence information processing system.

The overall configuration of a presence information processing system according to the third embodiment is the same as that of the second embodiment (see FIG. 10), and is therefore not further described.

FIG. 15 schematically illustrates the presence information processing system according to the third embodiment. As shown in FIG. 15, the presence information processing system 1 includes three types of information processing devices 10 functioning as clients: PCs 41A, 41B, and 41C (hereinafter, collectively referred to as “PC 41”); printers 42A and 42B (hereinafter, collectively referred to as “printer 42”); and copiers 43A and 43B (hereinafter, collectively referred to as “copier 43”). In the P2P network shown in FIG. 15, there are four peer groups: a net peer group including all of the information processing devices 10, a person peer group including the PCs 41A through 41C, a printer peer group including the PC 41A and the printers 42A and 42B, and a copier peer group including the PC 41C and the copiers 43A and 43B. The peer groups to be formed are not limited thereto.

Information can be shared among peers in the same peer group. Furthermore, all of the peers belong to the net peer group. Processes corresponding to the peer groups in the P2P network such as creating/discarding a peer group, participating in a peer group, and providing services in the peer group can be performed according to existing P2P logic.

All peers belong to the net peer group, and share a presence document schema representing the basic format of a presence document in the net peer group. Presence information that is extended by the type of information processing device is described in the presence document created in accordance with the presence document schema. Accordingly, various types of presence information can be described.

In the PC 41, an application reflecting the presence information of the user is installed. In the example shown in FIG. 15, all of the PCs 41 belong to the people peer group, and share a presence document schema representing the presence information of people.

In the printer 42, a program reflecting the presence information of the printer 42 is operating. In the example shown in FIG. 15, all of the printers 42 belong to the printer peer group, and share a presence document schema representing the presence information of the printer 24 in the printer peer group, such as “idle”, “offline”, and “printing”. Some of the PCs 41 belong to the printer peer group for viewing the presence information of the printer 42, and for subscribing to the presence document of the printer 42. It is possible to prohibit the PC 41 from creating a presence document by using the presence information of the printer 42. In this case, the PC 41 only behaves as a watcher in the printer peer group.

In the copier 43, a program reflecting the presence information of the copier 43 is operating. In the example of FIG. 15, all of the copiers 43 belong to the copier peer group, and share a presence document schema representing the presence information of the copier 43 in the copier peer group, such as “idle”, “offline”, and “copying”. Some of the PCs 41 belong to the copier peer group for viewing the presence information of the copier 43, and for subscribing to the presence document of the copier 43. It is possible to prohibit the PC 41 from creating a presence document by using the presence information of the copier 43. In this case, the PC 41 only behaves as a watcher in the copier peer group.

According to the above described configuration, in the presence information processing system 1, plural different types of presence document schemas are shared, such as presence information of people, presence information of printers, and presence information of copiers. Particularly, the presence document schema is shared only among information processing devices that use the same presence information, thereby enhancing efficiency in sharing presence document schema.

There is a presence document schema that is commonly used by all of the information processing devices 10, and therefore it is necessary to appropriately be aware of the presence document schema that is used to interpret the presence document subscribed to by each information processing device 10.

(Example of Sharing Presence Information)

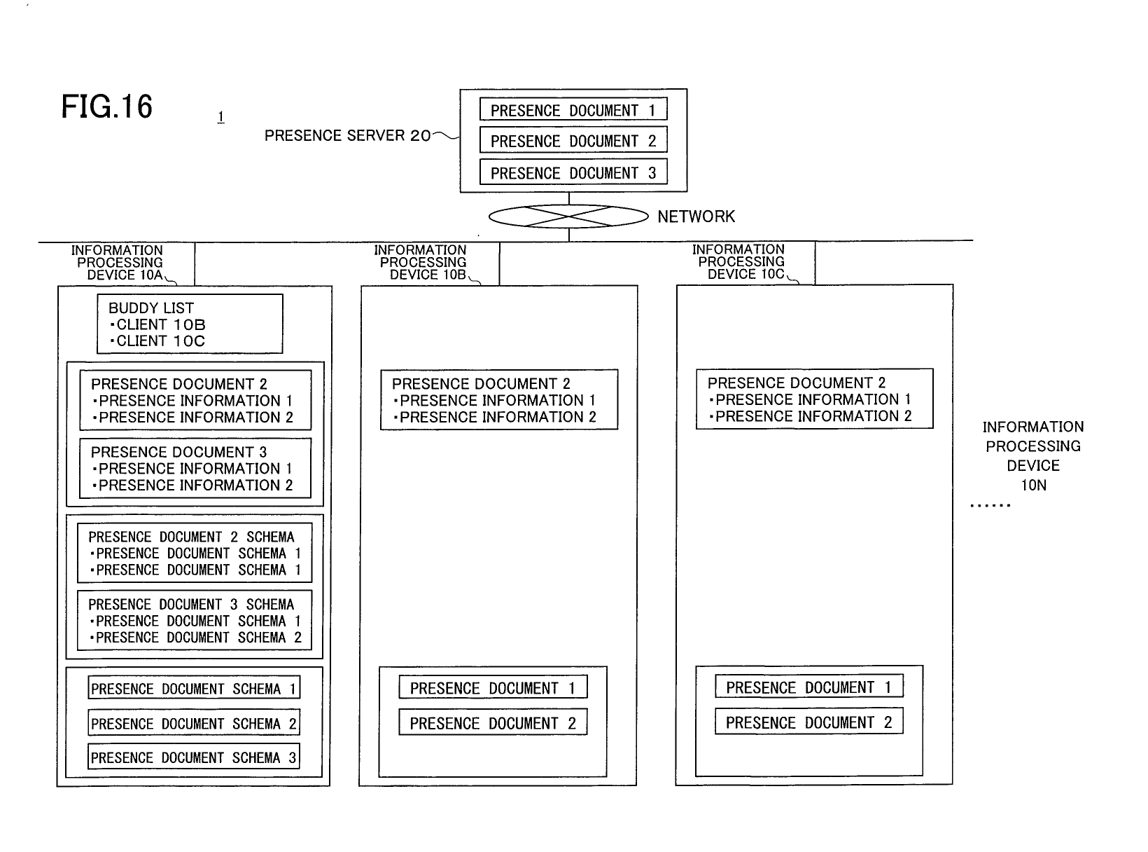

FIG. 16 is a schematic diagram of the data structure for describing how presence information is shared according to the third embodiment. In this example, the information processing device 10A that is participating in the presence information processing system 1 receives presence information provided from the information processing device 10B and the information processing device 10C that are of different types from that of the information processing device 10A. It is assumed that the presence information processing system 1 is the net peer group shown in FIG. 15. Furthermore, the information processing device 10A corresponds to the PC 41A, and the information processing device 10B and the information processing device 10C correspond to the printer 42A and the printer 42B, respectively.

First, it is assumed that a list of image processing devices (in this example, the printer 42A and the printer 42B), which are the sources providing the presence information to be acquired, is stored beforehand in the storage device of the PC 41A as a buddy list (presentity list).

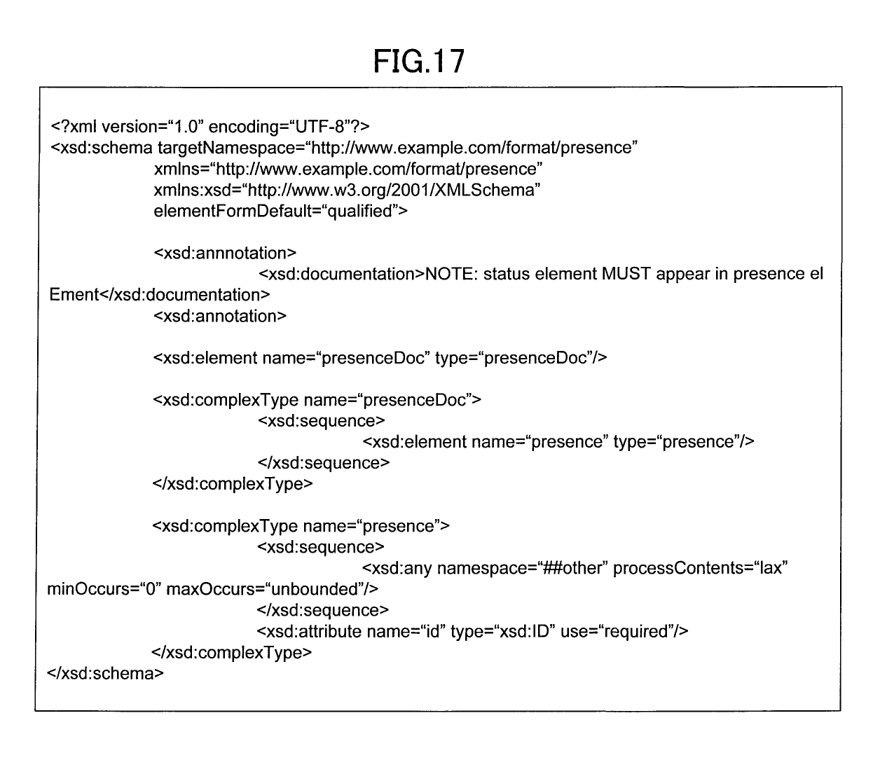

When the PC 41A participates in the printer peer group, the printer 42A and the printer 42B acquire a presence document schema as shown in FIG. 17.

FIG. 17 illustrates an example of a schema representing the basic format (structure) of a presence document shared in the presence information processing system. The presence document schema shown in FIG. 17 is described with the use of XML schema. The presence document schema can be described in any format other than XML schema.

The presence document schema shown in FIG. 17 includes definitions pertaining to a <presence> element for describing such presence information. In the example shown in FIG. 17, the <xsd:complexType name=“presence”> element does not include the line of <xsd:element ref=“status” minOccurs=“0”> which is described in the example shown in FIG. 3. This means that is possible to describe an element by each type of presence information in the <presence> element in the presence document, which can be freely associated with plural types of presence information. In this manner, the presence document schema defines at least one of the vocabulary of presence information and the structure of the presence document in which the presence information is described. Incidentally, semantics cannot be expressed in the XML Schema format, and therefore it is acknowledged beforehand that the presence information is described in the <presence> element.

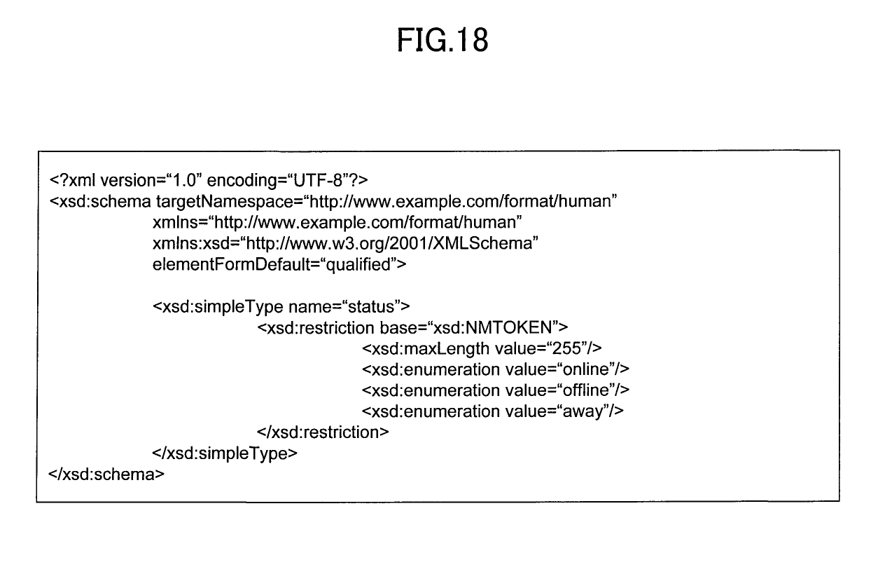

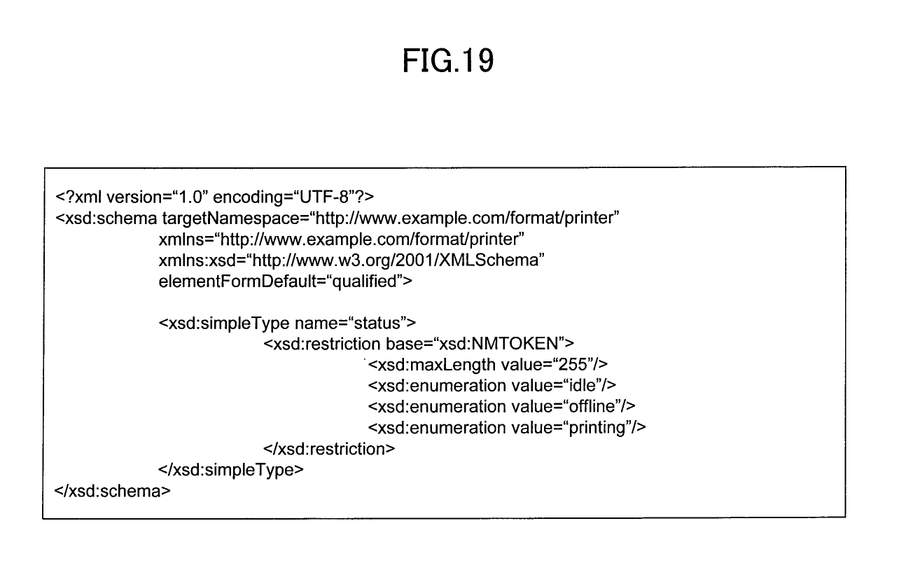

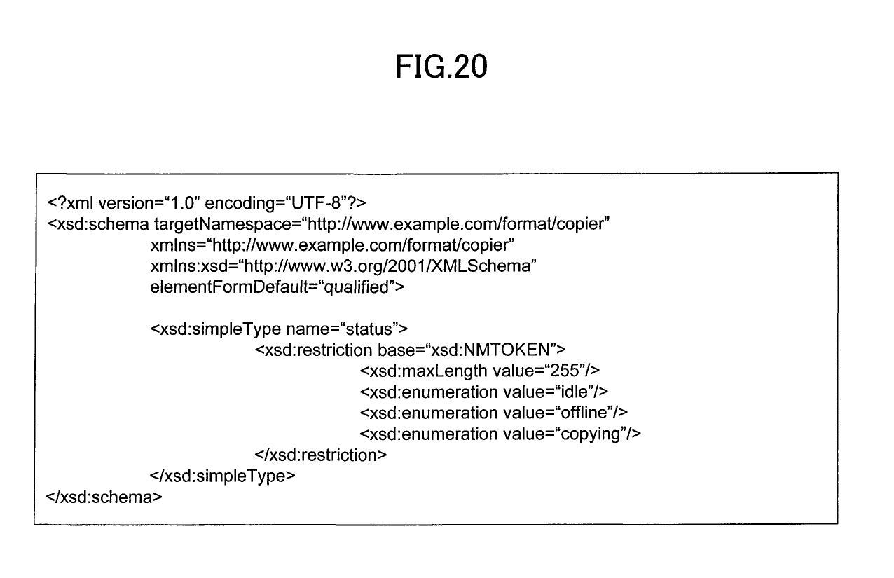

FIG. 18 illustrates an example of the presence document schema representing the presence information of people being shared in the people peer group, FIG. 19 illustrates an example of the presence document schema representing the presence information of printers being shared in the printer peer group, and FIG. 20 illustrates an example of the presence document schema representing the presence information of copiers being shared in the copier peer group.

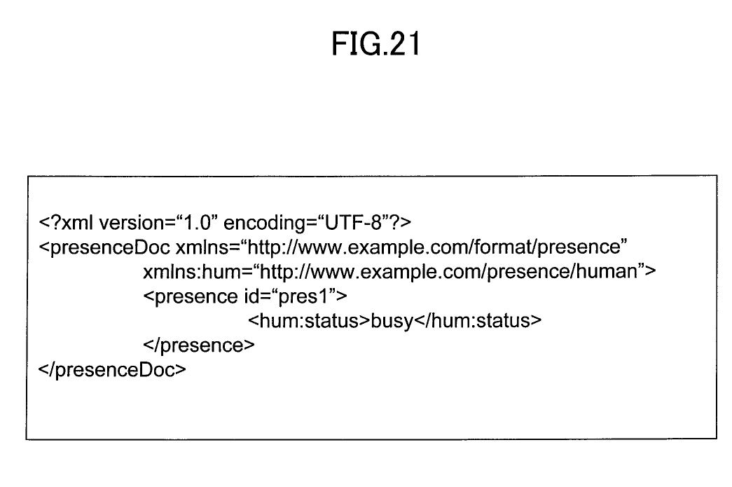

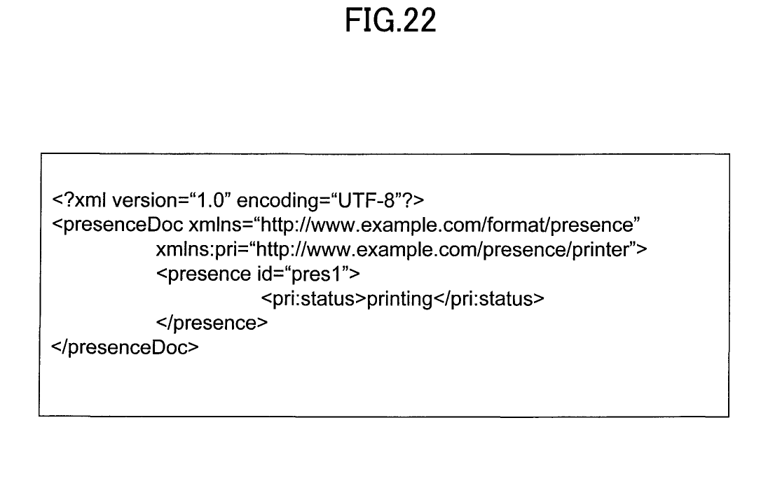

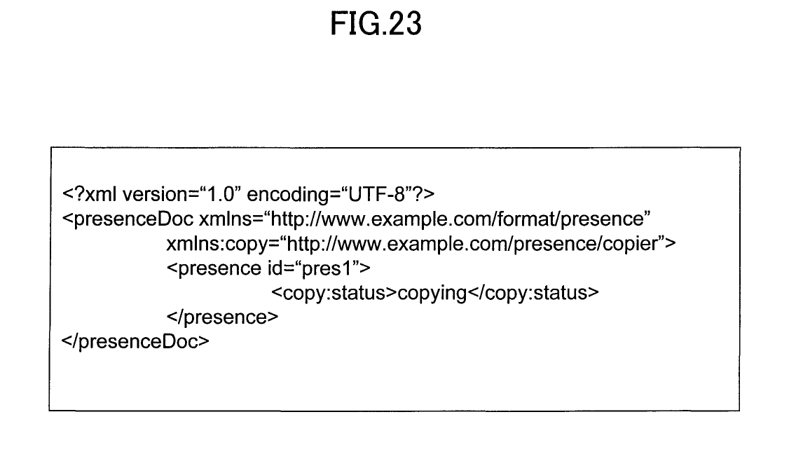

By applying these presence document schemas, the PC 41 can create a presence document as shown in FIG. 21, the printer 42 can create a presence document as shown in FIG. 22, and the copier 43 can create a presence document as shown in FIG. 23. The peers that have received these presence documents can interpret the corresponding presence documents in accordance with the schemas. FIGS. 21, 22, and 23 illustrate an example of a presence document representing presence information of a person, an example of a presence document representing presence information of a printer, and an example of a presence document representing presence information of a copier, respectively.

A presence document schema is shared in each peer group, and therefore, an information processing device 10 can interpret the presence information of an information processing device 10 of a different type, as long as they both belong to the same peer group. For example, the PC 41A that also belongs to the printer peer group can interpret the presence information of the printers 42A and 42B.

A peer can participate in a peer group when it is necessary to interpret presence information provided by that peer group. By participating in a peer group, the peer can acquire the presence document schema of the presence document provided in the peer group and interpret the presence document provided by a peer in the peer group.

A peer can separate from any peer group to which it presently belongs when it no longer needs to acquire the presence information provided by a peer in the corresponding peer group.

When a request for subscribing to a presence document is received, the presence server 20 checks the peer groups to which the requesting peer and the target peer belong. When these peers belong to different peer groups, the presence server 20 can reject (prohibit) the presence document subscription request. Accordingly, it is possible to prevent information from being provided to a different peer group, so that the information can be provided with increased security. In a method where the peer manages the presence document instead of the presence server 20 managing the presence document, such a problem will not arise.

Furthermore, the peer can create a new peer group. When a new peer group is created, the peer creates a presence document schema shared in this peer group, and shares it with other peers. The method of creating and sharing a presence document schema is the same as that of the second embodiment. Accordingly, the information processing device 10 that uses the new presence information can be added to the presence information processing system 1.

A peer group may be discarded by a peer in a peer group. Alternatively, the administrator of the network may delete a peer group.

The processes of editing, creating and changing the presence document schema in the peer group are performed in the same manner as the first embodiment or the second embodiment described above.

As described above, in the presence information processing system 1, plural different types of presence document schemas can be shared, such as those for the presence information of people, the presence information of printers, and the presence information of copiers. Accordingly, plural different types of presence document schemas can be used according to need in a single presence information processing system 1.

According to one embodiment of the present invention, there is provided a presence information processing system in which plural information processing devices are connected for exchanging presence information among each other via a network, the presence information processing system including a schema information sharing unit that operates such that the plural information processing devices can share a presence document schema representing at least one of a structure of a presence document in which the presence information is described and vocabulary of the presence information.

Additionally, according to one embodiment of the present invention, the schema information sharing unit operates such that the plural information processing devices can share plural types of the presence document schemas according to types of the presence information.

Additionally, according to one embodiment of the present invention, the schema information sharing unit operates such that those among the plural information processing devices that use the same type of the presence information can share the presence document schema that corresponds to the same type of the presence information.

Additionally, according to one embodiment of the present invention, at least one of the plural information processing devices includes a presence document schema acquiring unit configured to acquire the presence document schema being shared among the plural information processing devices with the use of the schema information sharing unit, in the event that the at least one of the plural information processing devices is connected to the presence information processing system.

Additionally, according to one embodiment of the present invention, the at least one of the plural information processing devices further includes a revision managing unit configured to manage a revision number of the presence document schema acquired by the presence document schema acquiring unit; and a presence document schema revising unit configured to make a comparison between the revision number being managed by the revision managing unit and another revision number of the presence document schema corresponding to the presence document which is received from one of the plural information processing devices other than the at least one of the plural information processing devices, and to revise the presence document schema determined as having a lower revision number as a result of the comparison.

Additionally, according to one embodiment of the present invention, in the event that the revision number being managed by the revision managing unit is older than the other revision number of the presence document schema corresponding to the presence document which is received from the other one of the plural information processing devices, the presence document schema revising unit gives an instruction of acquiring the presence document schema corresponding to the presence document which is received from the other one of the plural information processing devices.

Additionally, according to one embodiment of the present invention, in the event that the revision number being managed by the revision managing unit is newer than the other revision number of the presence document schema corresponding to the presence document which is received from the other one of the plural information processing devices, the presence document schema revising unit gives an instruction of revising the presence document schema corresponding to the presence document which is received from the other one of the plural information processing devices.

Additionally, according to one embodiment of the present invention, the presence information processing system further includes a presence document schema control unit configured to create, edit, or add the presence document schema, wherein the schema information sharing unit operates such that the plural information processing devices can share the presence document schema that has been created, edited, or added by the presence document schema control unit.

Additionally, according to one embodiment of the present invention, at least one of the plural information processing devices includes a presence document schema acquiring unit configured to acquire the presence document schema being shared among the plural information processing devices with the use of the schema information sharing unit, in the event that the at least one of the plural information processing devices is connected to the presence information processing system; and in the event that the presence document schema acquiring unit acquires the present document schema that has been edited, the presence document schema acquiring unit acquires an edited part of the present document schema that has been edited.

Additionally, according to one embodiment of the present invention, the presence document schema control unit is further configured to delete the presence document schema; and the schema information sharing unit operates such that the plural information processing devices can share the presence document schema other than the presence document schema that has been deleted by the presence document schema control unit.

Additionally, according to one embodiment of the present invention, the presence document schema control unit is further configured to change the presence document schema presently used to another different presence document schema.

Additionally, according to one embodiment of the present invention, the presence information processing system further includes a presence document sharing unit configured to operate such that the plural information processing devices can share the presence document created in accordance with the presence document schema, wherein in the event that the presence document schema presently used is changed, the presence document sharing unit operates such that the plural information processing devices can share the presence document created in accordance with the presence document schema that has been changed.

Additionally, according to one embodiment of the present invention, the presence information processing system further includes a presence document conversion document creating unit configured to create a presence document conversion document, wherein in the event that the presence document schema is changed, the presence document that has been created in accordance with the presence document schema before being changed is converted, based on the presence document conversion document, so as to comply with the present document schema that has been changed, wherein in the event that the presence document schema presently used is changed, the schema information sharing unit converts a predetermined presence document within the presence information processing system based on the presence document conversion document created by the presence document conversion document creating unit.

Additionally, according to one embodiment of the present invention, the presence information processing system further includes a presence document schema managing server device which can be accessed by the plural information processing devices and which includes the schema information sharing unit.

Additionally, according to one embodiment of the present invention, the presence document schema is operated by the presence document schema managing server or a predetermined one of the plural information processing devices.

Additionally, according to one embodiment of the present invention, the presence document schema can be operated only by privileged users.

Additionally, according to one embodiment of the present invention, the presence information processing system includes a peer-to-peer network in which the plural information processing devices are connected to each other; and at least one of the plural information processing devices includes the schema information sharing unit.

Additionally, according to one embodiment of the present invention, there is provided an information processing device in a presence information processing system in which plural information processing devices are connected for exchanging presence information among each other via a network, the information processing device including a schema information sharing unit that operates such that the information processing device and the plural information processing devices can share a presence document schema representing at least one of a structure of a presence document in which the presence information is described and vocabulary of the presence information.

Additionally, according to one embodiment of the present invention, there is provided a presence document schema managing server configured to manage a presence document schema for describing presence information, the presence document schema managing server being provided in a presence information processing system that includes plural information processing devices for exchanging the presence information among each other via a network, the presence document schema managing server including a presence document schema sending unit configured to send the presence document schema in response to a request from at least one of the plural information processing devices; an operating unit configured to operate the presence document schema; a revision number managing unit configured to manage a revision number of the presence document schema; a presence document conversion document creating unit configured to create a presence document conversion document, wherein in the event that the presence document schema being managed by the presence document schema managing server is changed by an operation of the operating unit, the presence document that has been created in accordance with the presence document schema before being changed is converted, based on the presence document conversion document, so as to comply with the present document schema that has been changed; a presence document conversion document sending unit configured to send, in response to a request from at least one of the plural information processing devices, the presence document conversion document created by the presence document conversion document creating unit; a change reporting unit configured to report, to the plural information processing devices, that the presence document schema has been changed by the operating unit; and an access right managing unit configured to manage an access right for accessing at least one of the presence document schema, the presence document conversion document, and the operating unit.

The present invention is not limited to the specifically disclosed embodiment, and variations and modifications may be made without departing from the scope of the present invention.

The present application is based on Japanese Priority Patent Application No. 2007-240092, filed on Sep. 14, 2007, the entire contents of which are hereby incorporated herein by reference.

What is claimed is:

1. A presence information processing system in which plural information processing devices are connected for exchanging presence information among each other via a network, the presence information processing system comprising:
a schema information sharing unit that operates such that the plural information processing devices can share a presence document schema representing at least one of a structure of a presence document in which the presence information is described and vocabulary of the presence information.

2. The presence information processing system according to claim 1, wherein:
the schema information sharing unit operates such that the plural information processing devices can share plural types of the presence document schemas according to types of the presence information.

3. The presence information processing system according to claim 1, wherein:
the schema information sharing unit operates such that those among the plural information processing devices that use the same type of the presence information can share the presence document schema that corresponds to the same type of the presence information.

4. The presence information processing system according to claim 1, wherein:
at least one of the plural information processing devices comprises a presence document schema acquiring unit configured to acquire the presence document schema being shared among the plural information processing devices with the use of the schema information sharing unit, in the event that the at least one of the plural information processing devices is connected to the presence information processing system.

5. The presence information processing system according to claim 4, wherein the at least one of the plural information processing devices further comprises:
a revision managing unit configured to manage a revision number of the presence document schema acquired by the presence document schema acquiring unit; and
a presence document schema revising unit configured to make a comparison between the revision number being managed by the revision managing unit and another revision number of the presence document schema corresponding to the presence document which is received from one of the plural information processing devices other than the at least one of the plural information processing devices, and to revise the presence document schema determined as having a lower revision number as a result of the comparison.

6. The presence information processing system according to claim 5, wherein:
in the event that the revision number being managed by the revision managing unit is older than the other revision number of the presence document schema corresponding to the presence document which is received from the other one of the plural information processing devices, the presence document schema revising unit gives an instruction of acquiring the presence document schema corresponding to the presence document which is received from the other one of the plural information processing devices.

7. The presence information processing system according to claim 5, wherein:
in the event that the revision number being managed by the revision managing unit is newer than the other revision number of the presence document schema corresponding to the presence document which is received from the other one of the plural information processing devices, the presence document schema revising unit gives an instruction of revising the presence document schema corresponding to the presence document which is received from the other one of the plural information processing devices.

8. The presence information processing system according to claim 1, further comprising:
a presence document schema control unit configured to create, edit, or add the presence document schema, wherein:
the schema information sharing unit operates such that the plural information processing devices can share the presence document schema that has been created, edited, or added by the presence document schema control unit.

9. The presence information processing system according to claim 8, wherein:
at least one of the plural information processing devices comprises a presence document schema acquiring unit configured to acquire the presence document schema being shared among the plural information processing devices with the use of the schema information sharing unit, in the event that the at least one of the plural information processing devices is connected to the presence information processing system; and
in the event that the presence document schema acquiring unit acquires the present document schema that has been edited, the presence document schema acquiring unit acquires an edited part of the present document schema that has been edited.

10. The presence information processing system according to claim 8, wherein:
the presence document schema control unit is further configured to delete the presence document schema; and
the schema information sharing unit operates such that the plural information processing devices can share the presence document schema other than the presence document schema that has been deleted by the presence document schema control unit.

11. The presence information processing system according to claim 8, wherein:
the presence document schema control unit is further configured to change the presence document schema presently used to another different presence document schema.

12. The presence information processing system according to claim 1, further comprising:
a presence document sharing unit configured to operate such that the plural information processing devices can share the presence document created in accordance with the presence document schema, wherein:
in the event that the presence document schema presently used is changed, the presence document sharing unit operates such that the plural information processing devices can share the presence document created in accordance with the presence document schema that has been changed.

13. The presence information processing system according to claim 10, further comprising:
a presence document conversion document creating unit configured to create a presence document conversion document, wherein in the event that the presence document schema is changed, the presence document that has been created in accordance with the presence document schema before being changed is converted, based on the presence document conversion document, so as to comply with the present document schema that has been changed, wherein:
in the event that the presence document schema presently used is changed, the schema information sharing unit converts a predetermined presence document within the presence information processing system based on the presence document conversion document created by the presence document conversion document creating unit.

14. The presence information processing system according to claim 1, further comprising:
a presence document schema managing server device which can be accessed by the plural information processing devices and which comprises the schema information sharing unit.

15. The presence information processing system according to claim 14, wherein:
the presence document schema is operated by the presence document schema managing server or a predetermined one of the plural information processing devices.

16. The presence information processing system according to claim 1, wherein:
the presence document schema can be operated only by privileged users.

17. The presence information processing system according to claim 1, wherein:
the presence information processing system comprises a peer-to-peer network in which the plural information processing devices are connected to each other; and
at least one of the plural information processing devices comprises the schema information sharing unit.

18. An information processing device in a presence information processing system in which plural information processing devices are connected for exchanging presence information among each other via a network, the information processing device comprising:
a schema information sharing unit that operates such that the information processing device and the plural information processing devices can share a presence document schema representing at least one of a structure of a presence document in which the presence information is described and vocabulary of the presence information.

19. A presence document schema managing server configured to manage a presence document schema for describing presence information, the presence document schema managing server being provided in a presence information processing system that comprises plural information processing devices for exchanging the presence information among each other via a network, the presence document schema managing server comprising:
a presence document schema sending unit configured to send the presence document schema in response to a request from at least one of the plural information processing devices;
an operating unit configured to operate the presence document schema;
a revision number managing unit configured to manage a revision number of the presence document schema;
a presence document conversion document creating unit configured to create a presence document conversion document, wherein in the event that the presence document schema being managed by the presence document schema managing server is changed by an operation of the operating unit, the presence document that has been created in accordance with the presence document schema before being changed is converted, based on the presence document conversion document, so as to comply with the present document schema that has been changed;
a presence document conversion document sending unit configured to send, in response to a request from at least one of the plural information processing devices, the presence document conversion document created by the presence document conversion document creating unit;
a change reporting unit configured to report, to the plural information processing devices, that the presence document schema has been changed by the operating unit; and
an access right managing unit configured to manage an access right for accessing at least one of the presence document schema, the presence document conversion document, and the operating unit.
